(19) United States
(12) Patent Application Publication
(10) Pub. No.: US 2009/0006863 A1
(43) Pub. Date: Jan. 1, 2009

(54) Storage system comprising encryption function and data guarantee method

(75) Inventor: Makio MIZUNO, Sagamihara (JP)

Correspondence Address: Stanley P. fisher;Reed Smith LLP, 3110 Fairview Park Drive, Suite 1400, Fals Church, VA, 22042-4503, US

(73) Assignee: Hitachi, Ltd.

(21) Appl. No.: 12/007,312

(22) Filed: Jan. 9, 2008

(30) Foreign Application Priority Data
Jun. 28, 2007 (JP) 2007-170926

(51) Int. Cl. H04L 9/00

(52) U.S. Cl. 713/190

(57) ABSTRACT

This storage system includes a host computer for issuing a read command or a write command of data, a pair of logical volumes corresponding to a pair of virtual devices to be recognized by the host computer, and a device interposed between the host computer and the pair of logical volumes and having a function of encrypting and decrypting data. The storage system additionally includes a path management unit for specifying one path to each of the logical volumes from a plurality of data transfer paths between the host computer and the pair of logical volumes for transferring encrypted data or decrypted data which was encrypted or decrypted via the device with data encryption or decryption function based on a read command or a write command of data from the host computer.

### CROSS REFERENCES

This application relates to and claims priority from Japanese Patent Application No. 2007-170926, filed on Jun. 28, 2007, the entire disclosure of which is incorporated herein by reference.

### BACKGROUND

The present invention relates to a storage system and a data guarantee method having a function for encrypting and decrypting data.

As one security measure of computers and the like, there is encryption technology of data (refer to Japanese Patent Laid-Open Publication No. 2002-217887). Processing for performing encryption (hereinafter referred to as “encryption processing”) or processing for performing decryption (hereinafter referred to as “decryption processing”) is realized with semiconductor components or software. Nevertheless, when using semiconductor components, there is fear of a malfunction due to radiation such as a rays. On the other hand, when using software, there is fear of a failure such as a computation error in a certain specified data pattern.

In recent years, demands for ensuring the security of storage systems are increasing. An encryption processing dedicated device or a disk controller with a built-in encryption processing function may be used to encrypt data to be stored in a disk controller.

Meanwhile, with an information processing system having a plurality of logical data transfer paths between a computer and a storage apparatus, there is technology of selecting the appropriate data transfer path among the plurality of logical data transfer paths aiming to improve the reliability and performance (refer to Japanese Patent Laid-Open Publication No. 2006-154880).

### SUMMARY

With an encryption processing dedicated device, for instance, if a means for verifying whether data has been properly encrypted before encrypting such data sent from an external device and sending it to the disk controller is provided, even when a malfunction occurs during the encryption processing, it is possible to prevent data subject to erroneous encryption processing from being stored in the disk controller. Similarly, if a means for verifying whether data has been properly decrypted before decrypting such data, which has been sent from the disk controller and previously encrypted, and sending it to an external device is provided, even when a malfunction occurs during the decryption processing, it is possible to prevent data subject to erroneous decryption processing from reaching the external device.

Nevertheless, when the encryption processing dedicated device is not equipped with the foregoing verification means, data subject to erroneous encryption processing or decryption processing will reach the disk controller or the external device, and will change into data that is completely different from the original data that was lastly decrypted with the encryption processing dedicated device.

Meanwhile, for instance, there are a plurality of logical data transfer paths between a computer and a storage apparatus with an encryption processing dedicated device interposed therebetween. When mirroring of data is performed in the disk controller, even when data becomes garbled due to a malfunction of the encryption processing dedicated device as described above, by using the mirrored data, processing can be continued with a different encryption processing dedicated device from the malfunctioned encryption processing dedicated device.

The present invention was devised in view of the foregoing points. Thus, an object of the present invention is to propose a storage system and a data guarantee method for detecting data caused by the malfunction of an encryption processing dedicated device or a device with an encryption function and appropriately using a physical data transfer path when writing or reading the encrypted data.

In order to achieve the foregoing object, the present invention provides a storage system, comprising a host computer for issuing a read command or a write command of data, a pair of logical volumes corresponding to a pair of virtual devices to be recognized by the host computer, and a device interposed between the host computer and the pair of logical volumes and having a function of encrypting and decrypting data. The storage system further comprises a path management unit for specifying one path to each of the logical volumes from a plurality of data transfer paths between the host computer and the pair of logical volumes for transferring encrypted data or decrypted data which was encrypted or decrypted via the device with data encryption or decryption function based on a read command or a write command of data from the host computer.

Thereby, when writing or reading the encrypted data, it is possible to detect data caused by the malfunction in an encryption processing dedicated device or a device having an encryption function.

The present invention further provides a data guarantee method of a storage system comprising a host computer for issuing a read command or a write command of data, a pair of logical volumes corresponding to a pair of virtual devices to be recognized by the host computer, and a device interposed between the host computer and the pair of logical volumes and having a function of encrypting and decrypting data. The data guarantee method comprises a path management step of specifying one path to each of the logical volumes from a plurality of data transfer paths between the host computer and the pair of logical volumes for transferring encrypted data or decrypted data which was encrypted or decrypted via the device with data encryption or decryption function based on a read command or a write command of data from the host computer.

Thereby, when writing or reading the encrypted data, it is possible to detect data caused by the malfunction in an encryption processing dedicated device or a device having an encryption function.

Moreover, a specific mode of the present invention is configured as follows.

A storage system comprising plurality of host computer computers (hereinafter referred to as “host computers”) for issuing a data I/O request, a disk controller including a storage apparatus for storing data, and an encryption processing dedicated device for encrypting or decrypting data to be communicated between the host computers and the disk controller. The host computer includes a read-after-write mechanism for temporarily retaining write data in a storage area in the host computer when the data I/O request issued by the application to the disk controller is an output (write) request and reading the write data immediately after it is stored in the disk controller, a data comparison mechanism for comparing the write data read by the read-after-write mechanism and the write data temporarily stored in the storage area in the host computer, and a message transmission/reception mechanism for notifying the comparison result based on the data comparison mechanism. The disk controller includes a message processing mechanism for processing the message sent from the message transmission/reception mechanism of the host computer.

As another mode for achieving the object of the present invention, provided is a storage system comprising plurality of host computer computers for issuing a data I/O request, a disk controller including a storage apparatus for storing data, and an encryption processing dedicated device for encrypting or decrypting data to be communicated between the host computers and the disk controller and which is connected to the respective data transfer paths of the host computers and the disk controller. The host computer includes a error detection code addition/verification mechanism for creating and adding a error detection code from write data when the data I/O request issued from the application to the disk controller is an output (write) request, or verifies the error detection code added to the write data when the data I/O request is an input (read) request, a mirroring mechanism for controlling the write data so it is written into different logical volumes, a data transfer path between the host computer and the disk controller, a path management table for managing a virtual logical volume to be shown to the application, and a path management table control mechanism for controlling the path management table. The host computer refers to the path management table with regard to the data input (read) request issued by the application and sends such data input request from an I/O port communicable with one of the mirrored data, and simultaneously sends a subsequent data input (read) request from an I/O port communicable with the other mirrored data when the path management table control mechanism issues such data input (read) request. When the error detection code of data requested by the data input request that arrived from the disk controller and the error detection code created from such data do not coincide, the host computer refers to the path management table once again, sends a data input (read) request from an input port communicable with the other mirrored data according to the path management table, and similarly compares the error detection code of data with the error detection code created with the error detection code addition/verification mechanism.

As another mode for achieving the object of the present invention, provided is a storage system comprising a plurality of host computer computers for issuing a data I/O request, a disk controller including a storage apparatus for storing data, and an encryption processing dedicated device for encrypting or decrypting data to be communicated between the host computers and the disk controller and which is connected to the respective data transfer paths of the host computers and the disk controller. The host computer includes a mirroring mechanism for controlling the write data so it is written into different logical volumes when the data I/O request issued from the application to the disk controller is an output (write) request, a path management table for managing the data transfer path between the host computer and the disk controller and the virtual logical volume to be shown to the application, and a path management table control mechanism for controlling the path management table. The disk controller includes a data comparison mechanism for comparing the write data of the host computer encrypted with the encryption processing dedicated device that arrived from different data transfer paths, and the data comparison mechanism sends a reply showing an error to the host computer when, as a result of comprising the write data of the host computer encrypted with the encryption processing dedicated device that arrived from different data transfer paths, the write data do not coincide.

As another mode for achieving the object of the present invention, provided is a storage system comprising a plurality of host computer computers for issuing a data I/O request, a disk controller including a storage apparatus for storing data, and an encryption processing dedicated device for encrypting or decrypting data to be communicated between the host computers and the disk controller and which is connected to the respective data transfer paths of the host computers and the disk controller. The host computer includes a mirroring mechanism for controlling the write data so it is written into different logical volumes when the data I/O request issued from the application to the disk controller is an output (write) request, a mirroring data read mechanism for simultaneously reading both mirrored data, a path management table for managing the data transfer path between the host computer and the disk controller and the virtual logical volume to be shown to the application, and a path management table control mechanism for controlling the path management table. The host computer uses the mirroring data read mechanism to refer to the path management table with regard to the data input (read) request issued from the application, sends the data input (read) request from an I/O port communicable with both mirrored data, and uses the data comparison mechanism to compare the data requested in the data input request that arrived from the disk controller.

As another mode for achieving the object of the present invention, provided is a storage system comprising a plurality of host computer computers for issuing a data I/O request, and a disk controller including a storage apparatus for storing data. The disk controller includes an encryption/decryption mechanism for encrypting or decrypting data to be sent to and received from the host computer, and a error detection code addition/verification mechanism for adding a error detection code before encrypting the data received from the host computer using the encryption/decryption mechanism. The disk controller reads (or caches) data from the storage apparatus according to the data input (read) request issued by the application, uses the encryption/decryption mechanism to decrypt the data, and uses the error detection code addition/verification mechanism to verify the error detection code.

As another mode for achieving the object of the present invention, provided is a storage system comprising a plurality of host computer computers for issuing a data I/O request, a disk controller including a storage apparatus for storing data, a coupling device for mutually coupling the host computer and the disk controller, and an encryption processing dedicated device for encrypting or decrypting data to be communicated between the host computers and the disk controller. The host computer includes a mirroring mechanism for controlling the write data so it is written into different logical volumes when the data I/O request issued from the application to the disk controller is an output (write) request, a path management table for managing the data transfer path between the host computer and the disk controller and the virtual logical volume to be shown to the application, and a path management table control mechanism for controlling the path management table. The coupling device includes a data comparison mechanism for comparing the mirrored data that arrived from the host computer via different data transfer paths.

As another mode for achieving the object of the present invention, the path management table includes, at the least, an index number for identifying a physical path between the host computer and the disk controller, a number for identifying the I/O port of the host computer, a number for identifying the I/O port of the disk controller, a number for identifying the logical volume, a virtual device number to be shown to the application, an attribute showing whether the device is a mirrored virtual device, and a pointer showing the host computer I/O port to send the request during a data read or write request.

A pointer (hereinafter referred to as the “pointer”) showing the host computer I/O port to send the request during a data read request shows which data transfer path to use when there are a plurality of data transfer paths to a certain logical volume. When a malfunction occurs during the encryption or decryption processing in the encryption processing dedicated device on the data transfer path when reading one of the mirrored data, the other mirrored data is read to recover the data. Here, when the other mirrored data passes through the foregoing encryption processing dedicated device on the data transfer path, such data will be affected by the malfunction of the encryption or decryption processing. Thus, a data transfer path that is different from the foregoing data transfer path must be used. The role of the pointer is to control the data transfer paths of the mirrored data so that they will not overlap with each other.

According to the present invention, since it is possible to detect data during a malfunction in an encryption processing dedicated device or during the encryption processing in the disk controller at least during the reading or writing thereof, it is possible to reliable guarantee data in a storage system that supports the encryption function of the data to be stored.

### DESCRIPTION OF DRAWINGS

FIG. 1 is a diagram showing an example of a control method a data transfer path in a storage system;

FIG. 2 is a chart of a path management table used for explaining the control method of the data transfer path;

FIG. 3 is an explanatory diagram of the path management table showing the allocation of a virtual device used for explaining the control method of the data transfer path;

FIG. 4 is an explanatory diagram of the path management table showing the allocation of the virtual device used for explaining the control method of the data transfer path;

FIG. 5 is a flowchart showing the routine for creating the path management table used for explaining the control method of the data transfer path;

FIG. 6 is a flowchart showing virtual device allocation processing used for explaining the control method of the data transfer path;

FIG. 7 is an overall diagram of the storage system according a first embodiment;

FIG. 8 is a chart of the path management table in the first embodiment;

FIG. 9 is a flowchart showing virtual device allocation processing in the first embodiment;

FIG. 10 is a flowchart showing pointer allocation processing in the first embodiment;

FIG. 11 is a sequential diagram showing a data guarantee method in the first embodiment;

FIG. 12 is a sequential diagram showing the data guarantee method of the first embodiment;

FIG. 13 is a sequential diagram showing the data guarantee method of the first embodiment;

FIG. 14 is an overall diagram of the storage system in a second embodiment;

FIG. 15 is a chart of the path management table in the second embodiment;

FIG. 16 is a sequential diagram showing the data guarantee method in the second embodiment;

FIG. 17 is a sequential diagram showing the data guarantee method in the second embodiment;

FIG. 18 is a sequential diagram showing the data guarantee method in the second embodiment;

FIG. 19 is a sequential diagram showing the data guarantee method in the second embodiment;

FIG. 20 is a flowchart showing pointer movement processing in the second embodiment;

FIG. 21 is an overall diagram of the storage system in a third embodiment;

FIG. 22 is a sequential diagram showing the data guarantee method in the third embodiment;

FIG. 23 is a sequential diagram showing the data guarantee method in the third embodiment;

FIG. 24 is an overall diagram of the storage system in a fourth embodiment;

FIG. 25 is a sequential diagram showing the data guarantee method in the fourth embodiment;

FIG. 26 is a sequential diagram showing the data guarantee method in the fourth embodiment;

FIG. 27 is a sequential diagram showing the data guarantee method in the fourth embodiment;

FIG. 28 is an overall diagram of the storage system in a fifth embodiment;

FIG. 29 is a chart of the path management table in the fifth embodiment;

FIG. 30 is a sequential diagram showing the data guarantee method in the fifth embodiment;

FIG. 31 is a sequential diagram showing the data guarantee method in the fifth embodiment;

FIG. 32 is an overall diagram of the storage system in a sixth embodiment;

FIG. 33 is a sequential diagram showing the data guarantee method in the sixth embodiment;

FIG. 34 is a sequential diagram showing the data guarantee method in the sixth embodiment;

FIG. 35 is a sequential diagram showing the data guarantee method in the sixth embodiment; and

FIG. 36 is a sequential diagram showing the data guarantee method in the sixth embodiment.

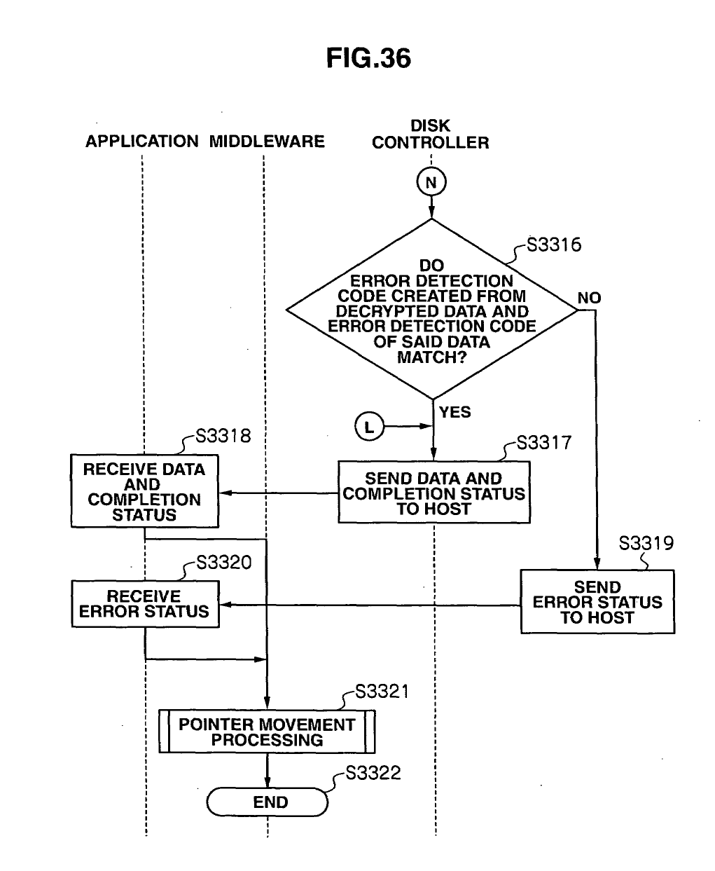

### DETAILED DESCRIPTION

The present invention is now explained in detail with reference to the attached drawings.

### (1) CONTROL METHOD OF DATA TRANSFER PATH USED IN PRESENT INVENTION

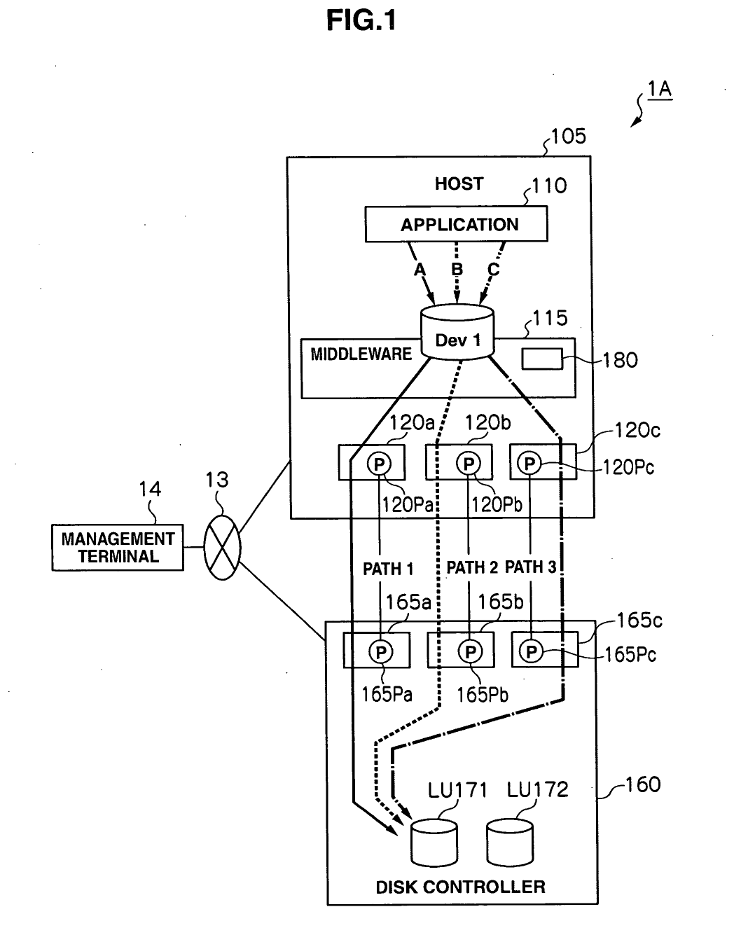

FIG. 1 is a diagram showing an example of the control method of a data transfer path between a host computer and a disk controller in a storage system. This invention will use this data transfer path control method.

FIG. 1 shows the storage system 1A.

The host computer 105 sends and receives data by using a storage area of a disk device. The host computer 105 is connected to the disk controller 140 via an HBA 120.

Since there are three HBAs 120 in FIG. 1, these are indicated as HBAs 120a, 120b, 120c for the sake of convenience. The middleware 115 will be described later.

The HBA 120 has an interface for the host computer 105 to communicate with the disk controller 140. As the interface corresponding to the HBA 120, for instance, SCSI (Small Computer System Interface), fibre channel, Ethernet (registered trademark) and the like may be used.

The disk controller 160 writes data into a cache memory (not shown) as a temporary writing area, or a disk device in response to a data transmission/reception request from the host computer 105, or contrarily sends the data stored in the cache memory or the disk to the host computer 105.

The host adapter 165 comprises an interface with the host computer. Since there are three host adapters in FIG. 1, these are indicated as host adapters 165a, 165b, 165c for the sake of convenience.

The logical volumes 171, 172 are volumes that are visible from the host computer (application). A logical volume refers to the respective areas in which the aggregate of a plurality of disk drives is partitioned into a plurality of areas, and is generally configured in RAID (Redundant Arrays of Inexpensive Disks) aiming to improve the performance and reliability.

There are a plurality of levels in RAID, and, for instance, there is RAID1 (also known as mirroring) for redundantly writing data, and RAID 3 or RAID 5 for partitioning data in certain units, writing these into separate disk drives, and writing a error detection code in the data. There are other RAID levels, but the explanation is omitted.

The disk controller 160, in addition to the host adapter 165 and the logical volume LU (Logical Unit), is configured from a cache memory, a shared memory for retaining control information in the disk controller, a disk adapter including an interface with the disk drive, a processor for controlling the host adapter and the disk adapter and performing data transfer control in the disk controller, a mutual coupling unit for mutually coupling these components. In explaining the control of the data transfer path between the host computer 105 and the disk controller 160, the configuration would suffice so as long as access is enabled at least from the host adapters 165a, 165b, 165c to the logical volumes LU 171, 172.

The host computer 105 and the disk controller 160 are connected to the management terminal 14 via the network 13.

The management terminal 14 is basically connected to the respective components configuring the storage system 1A, and monitors the status and makes various settings of the respective components. The management terminal also controls the middleware 115.

Referring to FIG. 1, there are three communication paths (sometimes referred to as “data transfer paths”) capable of sending and receiving data between the host computer 105 and the disk controller 160.

A communication path capable of sending and receiving data is the path between the HBA 120a and the host adapter 165a, the HBA 120b and the host adapter 165b, and the HBA 120c and the host adapter 165c.

When reviewing the host computer 105 (application 110), it is unclear as to which data transfer path should be used to access the logical volumes LU 171, 172. For instance, there is no problem in continuing to use the path of the HBA 120a and the host adapter 165a.

Nevertheless, there are the following advantages in using a plurality of data transfer paths.

For instance, when the path between the HBA 120a and the host adapter 165a cannot be used for some reason, processing can be continued if it is possible to use another data transfer path. Further, since there is a possibility that the processing performance will deteriorate as a result of the load concentrating on the host adapter 165a due to the continued use of the path between the HBA 120a and the host adapter 165a. Thus, the load can be balanced by using another data transfer path.

The middleware 115 plays the role of controlling this kind of data transfer path. The middleware 115 controls the data transfer path with the path management table 180.

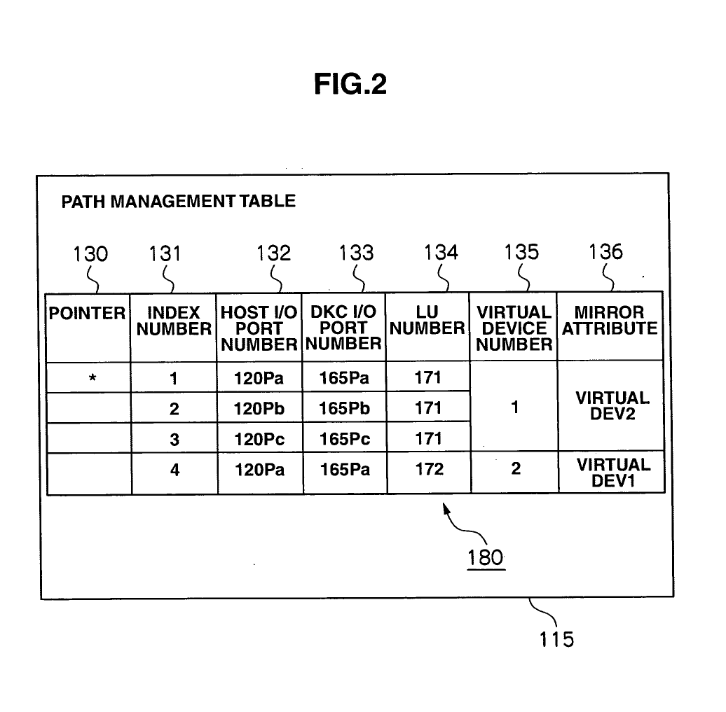

As shown in FIG. 2, the path management table 180 includes a “pointer” field 130, an “index number” field 131 for identifying the paths registered in the table, a “host computer I/O port number” field 132 for identifying the I/O port of the host computer, a “disk controller I/O port number” field 133 for identifying the I/O port of the disk controller, an “LU number” field 134 as a number of the logical volume accessible from the data transfer path decided based on the combination of the host computer I/O port number and the disk controller I/O port number, a “virtual device number” field 135 for identifying the logical volume to be virtually shown to the application 110, and a “mirror attribute” field 136 showing the virtual device number of the other party configuring the mirror.

The “pointer” field 130 shows the data transfer path to be used by the host computer 105 to access the logical volume LU of the disk controller 160. For example, with the path management table 180 of FIG. 2, this means that the data transfer path with the index number 1 (this is sometimes simply referred to as “index 1”) is used among the three data transfer paths to the logical volume LU 171.

As the operation of the pointer, for instance, when the objective is the load balancing of the data transfer path, the pointer is moved according to the round robin algorithm in the order of index 1, index 2, index 3, and index 1. Or, when the data transfer path cannot be used, the pointer is controlled so that this data transfer path cannot be used.

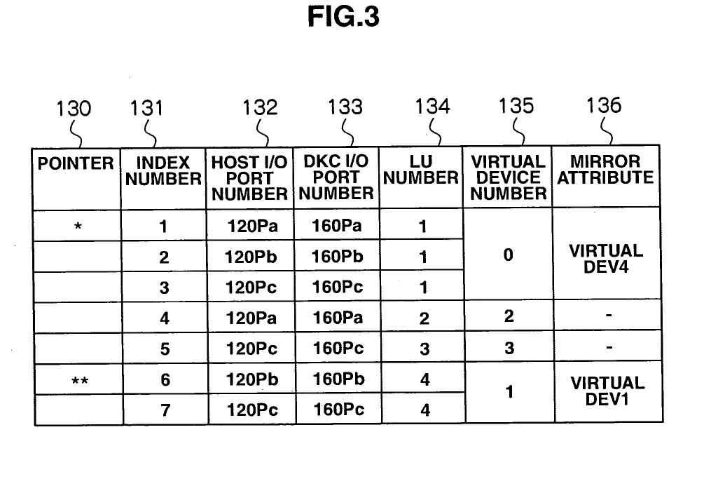

When allocating a virtual device number, the virtual device number is allocated for each index group belonging to the same logical volume number in the path management table. Specifically, as shown in FIG. 3, the virtual device numbers 0, 1 are allocated from the youngest index group (ascending order) of the index groups (index numbers 1 to 3 and index numbers 6 and 7) belonging to the same logical volume number. The virtual device numbers 2, 3 are allocated in order to the logical volumes 2, 3 that have no index group.

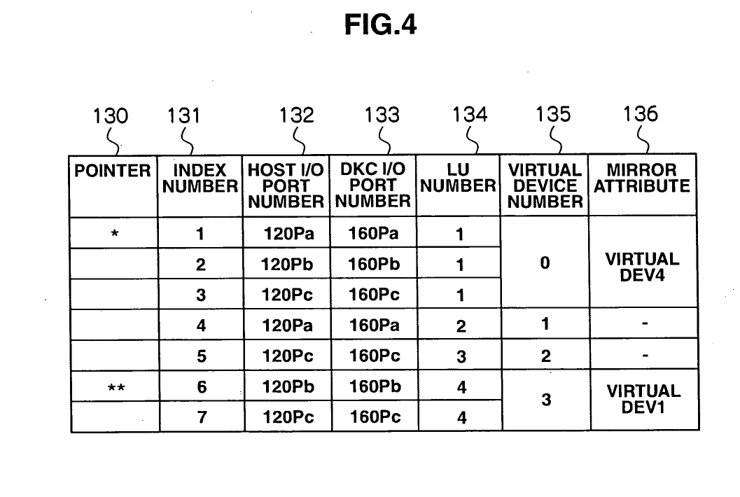

Further, as shown in FIG. 4, instead of first allocating the virtual device Dev from the index group, the virtual device numbers 0, 1, 2, 3 may also be allocated according to the ascending order of the index numbers.

The routine for creating the path management table 180 will be explained with reference to a separate drawing.

The virtual device Dev is a logical volume to be shown virtually to the application 110, and a volume associated with the logical volume LU. For instance, the application 110 of FIG. 1 is able to access the logical volume LU 171 with the three data transfer paths.

Specifically, this would be a host port 120Pa-DKC port 165Pa, a host port 120Pb-DKC port 165Pb, and a host port 120Pc-165Pc. The virtual device Dev, for example, this is provided as a means so that the application 110 will not have to be conscious about which data transfer path should be used to access the logical volume LU 171.

According to the path management table 180, the path 1 (index 1) shows that the logical volume LU 171 can be accessed by using the data transfer path between the host port 120Pa and the DKC port 165Pa. Similarly, the path 2 (index 2) shows that the logical volume LU 171 can be accessed using the data transfer path between the host port 120Pb and the DKC port 165Pb, and the path 3 (index 1) shows that the logical volume LU 171 can be accessed by using the data transfer path between the host port 120Pc and the DKC port 165Pc.

In other words, the middleware 115 allocates the virtual device Dev1 as the logical volume to be virtually shown to the application 110 since the application 110 is able to access the logical volume LU 171 from each of the three data transfer paths. The routine for allocating the virtual device Dev will be explained with reference to a separate drawing.

As a result of the above, it is possible to avoid the application 110 from becoming aware of the switching of the plurality of data transfer path, and make it seem as though a single data transfer path is used to access the logical volume LU 171.

Specifically, a case where a data read request is issued three consecutive times from the application 110 is now explained. FIG. 1 shows these data read requests A, B, C.

Foremost, when a data read request A is issued from the application 110 to the virtual device Dev1 (actually the logical volume LU 171 associated with the virtual device Dev1), the middleware 115 refers to the path management table 180, and uses the index 1 (path 1) to send the data read request A to the disk controller 160.

Subsequently, when a data read request B is issued from the application 110, the middleware 115 sends the data read request B to the disk controller 160 using the subsequent index 2 (path 2).

Finally, when a data read request C is issued from the application 110, the middleware 115 sends the data read request C to the disk controller 160 using the subsequent index 3 (path 3).

The foregoing operation is an algorithm generally known as a round robin, but the present invention is not limited thereto, and other algorithms may also be similarly applied. For example, the utilization of the resource (for instance, a memory or a processor) of the disk controller can be monitored, and the request may be preferentially sent to the DKC port 165Pa with the resource having the lowest utilization.

Meanwhile, when there is only one data transfer path, for instance, in FIG. 1, the data transfer path of the logical volume LU 172 is managed to be the host port 120Pa-DKC port 165Pa.

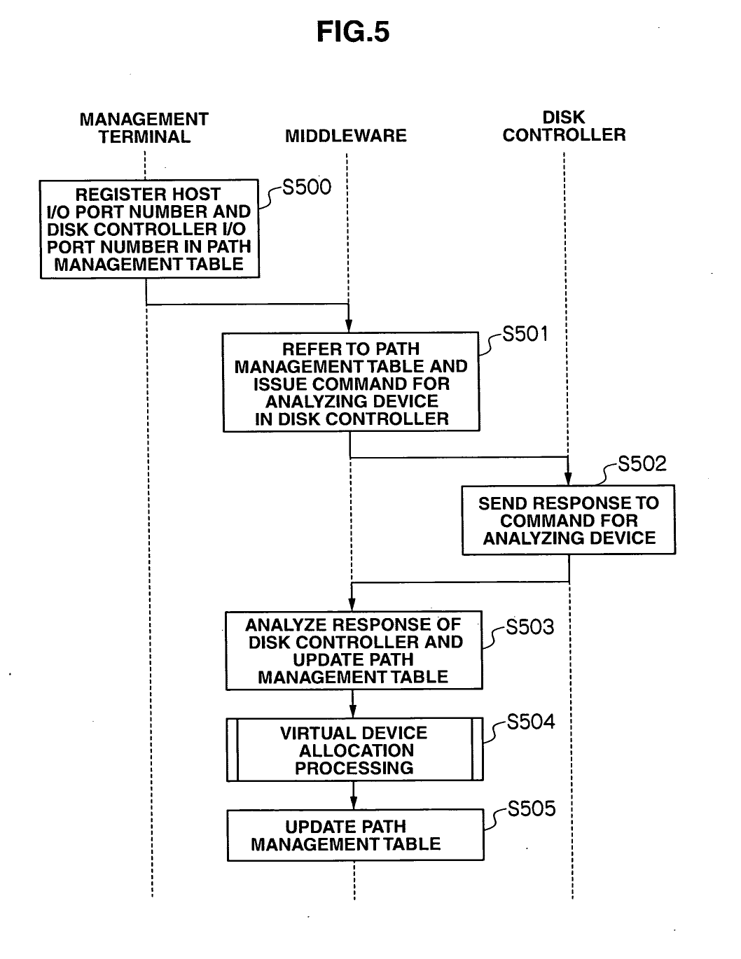

FIG. 5 is a flowchart showing the routine for creating the path management table 180. The creation processing of the path management table 180 is executed by the middleware 115 based on a path management table creation program in the memory of the host computer 105.

The path management table 180 is created in the middleware 115. Let it be assumed that the configuration of the storage system is the same as the storage system 1A of FIG. 1.

As the routine of creating the path management table 180, foremost, the management terminal 14 registers the host port and the DKC port (S500). At this point in time, the LU number and the virtual Dev number are not registered.

Subsequently, the middleware 115 refers to the path management table 180, and issues a command for analyzing the device (logical volume) in the disk controller 160 through the registered path (S501). As the analysis command, for instance, there are an Inquiry command and a Report LUN command in a SCSI protocol, and the type, capacity and other matters of the device will become evident by combining these commands.

The disk controller 160 sends a prescribed reply to the middleware 115 in responds to the command issued from the middleware 115 (S502), and the middleware 115 analyzes this reply and reflects the result in the path management table 180 (S503).

The middleware 115 thereafter performs the allocation processing of the virtual volume Dev (S504), and this will be explained with reference to a separate drawing.

Finally, the middleware 115 completes a table like the path management table 180 of FIG. 1 at the point in time that the number of the allocated virtual volume Dev is reflected in the path management table 180.

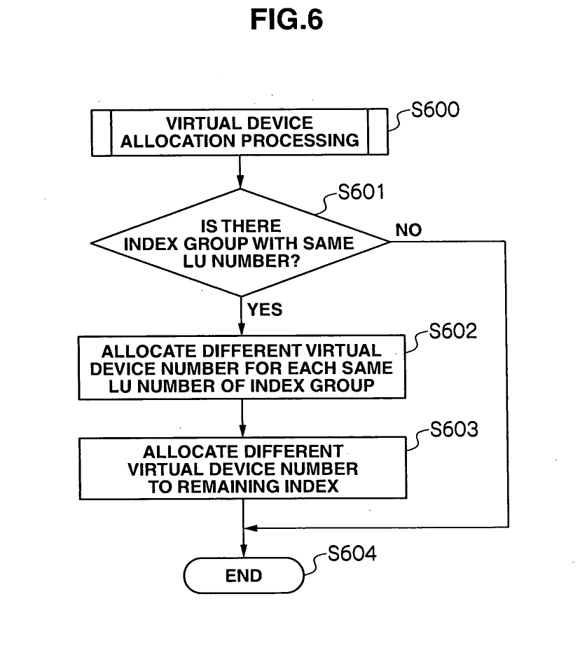

FIG. 6 is a diagram showing a flowchart of the virtual device allocation processing. The virtual device allocation processing is executed by the middleware 115 based on a virtual device allocation program (not shown) in the memory of the host computer 105. Incidentally, the path management table 180 of FIG. 2 is also used in the explanation of the flowchart of FIG. 6 for the sake of convenience.

The virtual device allocation processing is started at the point in time the processing up to step S503 of FIG. 5 is complete (S600). At this moment, there are three data transfer paths.

As the routine for allocating the virtual device, foremost, the middleware 115 refers to the path management table 180, checks the LU number of the respective indexes, and determines whether there is an index group having the same LU number (S601).

When the middleware 115 determines that there is an index group having the same LU number (S601: YES), it allocates the virtual device number to each same LU number to which the extracted index group belongs (S602).

For instance, as a result of step S601, as shown in FIG. 2, the index groups 1, 2, 3 are extracted with regard to the logical unit LU 171. And as a result of step S602, the middleware 115 allocates the virtual device number “1” to the index groups 1, 2, 3. In FIG. 2, since there are no other index groups having the same LU number, the routine proceeds to the subsequent step.

In other words, when the middleware 115 determines that there is no index group having the same LU number (S601: NO), it performs the processing at step S603.

The middleware 115 allocates the virtual device number that is different from the number allocated at step S602 to the remaining indexes (S603).

For example, as a result of step S603, the middleware 115 allocates the virtual device number “2” to the index 4.

When the middleware 115 thereby ends this virtual device allocation processing (S604), it performs the processing at step S505 explained at FIG. 5.

Thereby, the middleware 115 is able to determine that the data transfer path that can be used subsequently is the index 1 in relation to the virtual device number 1.

Incidentally, there is no particular limitation in the method of affixing the pointer, and, for instance, the point may always be affixed to the index of the youngest number. The method of updating the pointer in this invention will be described later.

The first to sixth embodiments can be realized by using the data transfer path control illustrated in FIG. 1.

### (2) FIRST EMBODIMENT

(2-1) System Configuration

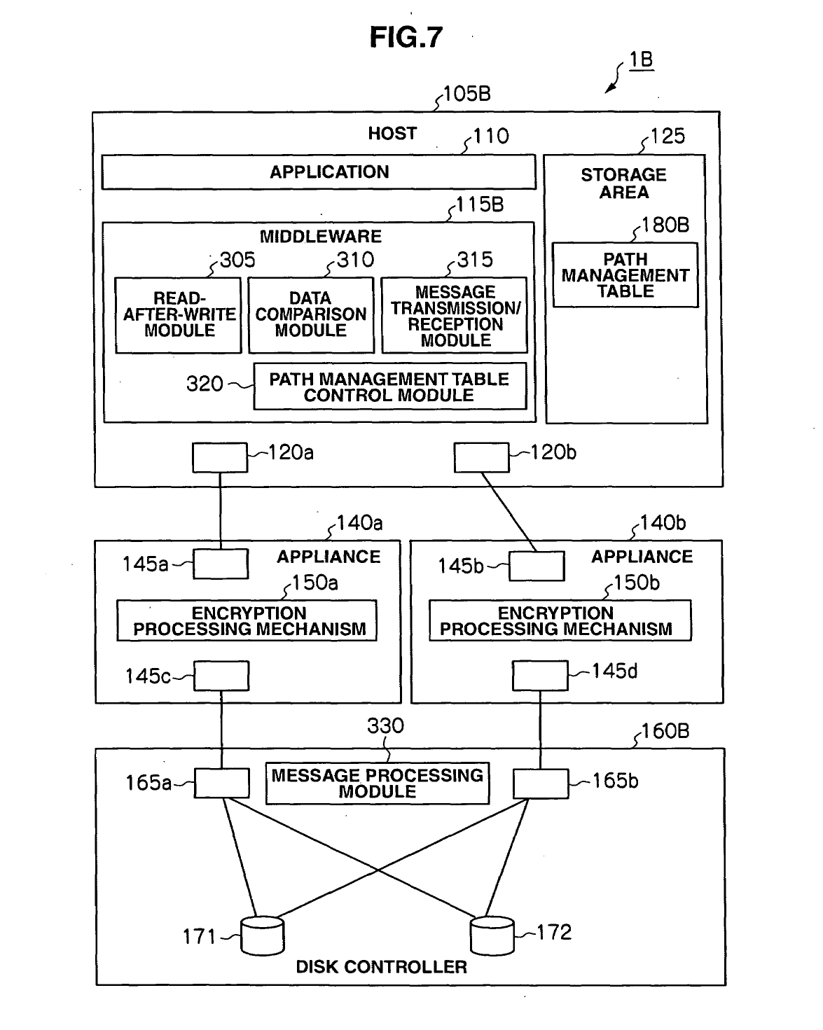

FIG. 7 is a diagram showing the configuration of the storage system in the first embodiment. FIG. 7 shows the storage system 1B in the first embodiment.

Incidentally, the storage system 1B shown in FIG. 7 is basically the same as the storage system 1A explained in FIG. 1, and the same reference numerals are given to the same constituent elements. Only the constituent elements that are different from the storage system 1A explained in FIG. 1 are explained below.

In the first embodiment, in order to guarantee the data integrity of the storage system 1B comprising an encryption function, immediately after writing data from the host computer 105B into the disk controller 160B, such data is read, and the data written into and the data read from the host computer 105B are compared.

The encryption processing and decryption processing of data are collectively referred to as “encryption processing.” Further, data that has not been encrypted is referred to as a “plain text,” and data that has been encrypted is referred to as an “encrypted text.”

Foremost, the storage system 1B for realizing the encryption processing in the first embodiment is of a configuration where an encryption processing dedicated device (hereinafter sometimes referred to as an “appliance”) 140 is connected between the host computer 105B and the disk controller 160B.

The appliance 140 comprises an encryption processing mechanism 150 for executing the encryption processing, and an I/O port 145 including an interface with the host computer 105B and an interface with the disk controller 160B.

Incidentally, FIG. 7 shows a configuration where the appliance is arranged on the respective data transfer paths, and these are indicated as appliances 140a, 140b for differentiation. Further, the I/O ports are indicated as follows. Regarding the appliance 140a, the host computer-side I/O port is I/O port 145a and the disk controller-side I/O port is I/O port 145c; regarding the appliance 140b, the host computer-side I/O port is I/O port 145b and the disk controller-side I/O port is I/O port 145d. Incidentally, since data only flows from the I/O ports 145a to 145c in the appliance 140a, there will be no influence on the data transfer path between the host computer port 120Pb and the DKC port 165Pb. Similarly, since data only flows from the I/O ports 145b to 145d in the appliance 140b, there will be no influence on the data transfer path between the host computer port 120Pa and the DKC port 165Pa.

As a result of installing the appliance 140, the flow of data between the host computer 105B and the disk controller 160B will be as follows. In other words, plain text will flow between the host computer 105B and the appliance 140, and encrypted text will flow between the appliance 140 and the logical units LU 171, 172.

The host computer 105B comprises a read-after-write module 305, a data comparison module 310, a message transmission/reception module 315, a path management table control module 320, and a path management table 180B.

The disk controller 160B comprises a message processing module 330.

These modules and tables are required for writing data from the host computer 105B into the disk controller 160B and immediately thereafter reading such data, and then comparing the data written into and the data read from the host computer 105B.

The read-after-write module 305 writes write data into the storage area 125 simultaneously with issuing the read request of data written based on the data write request from the application 110.

The data comparison module 310 compares the write data written into the storage area 125 and the data read by the read-after-write module 305.

The message transmission/reception module 315 sends the comparison result of the data comparison module 310 as a message to the disk controller 160B.

The path management table control module 320 controls the path management table 325.

The message processing module 330 processes the message sent from the message transmission/reception module 315.

The reason a message is exchanged between the message transmission/reception module 315 and the message processing module 330 is to prevent the data referral from other host computers. If a malfunction occurs in the appliance, erroneous data will consequently be sent to the other host computers. Thus, the disk controller 160B leaves the data written from the host computer 105B in a temporary suspended status until it receives the message from the message transmission/reception module 315.

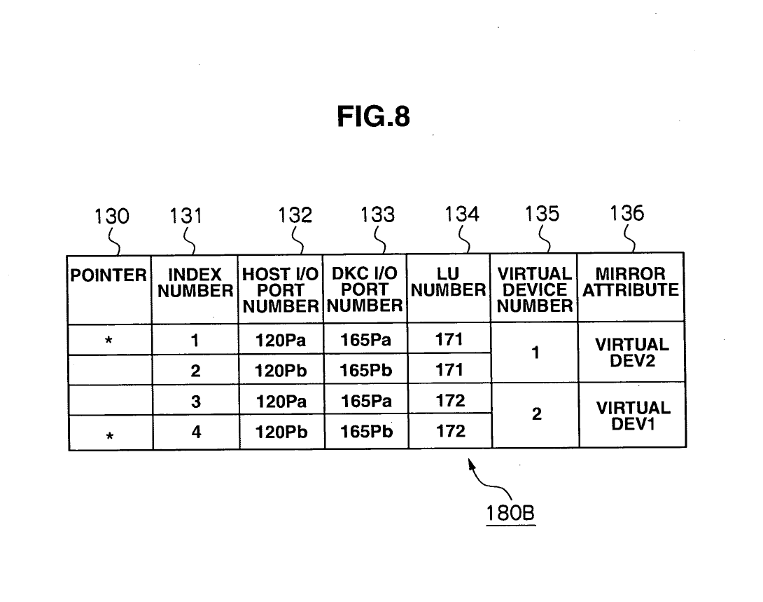

FIG. 8 is a diagram showing an example of the path management table 180B in the first embodiment.

Incidentally, items of the path management table 180B are the same as the items of the path management table 180 explained above, and the detailed explanation thereof is omitted.

(2-2) Virtual Device Allocation Processing

The flow of the virtual device allocation processing and the pointer allocation processing of the path management table 180B in this embodiment is different from FIG. 6.

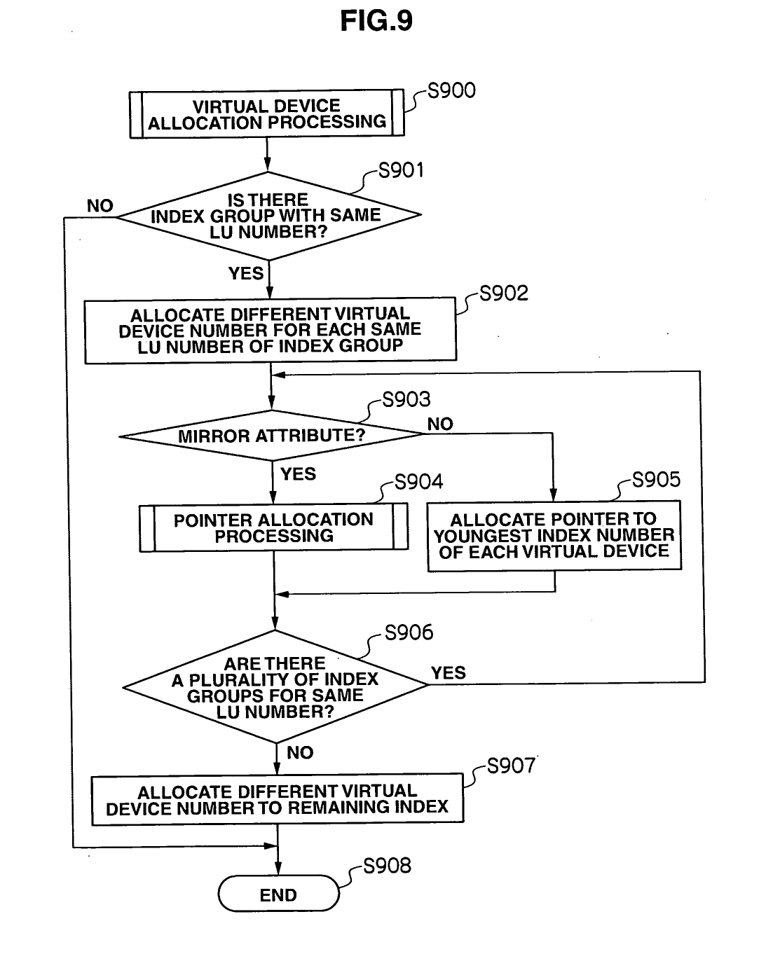

FIG. 9 is a flowchart of the virtual device allocation processing of the path management table 180B in the first embodiment.

The virtual device allocation processing is executed by the middleware 115B based on a virtual device allocation program (not shown) in the memory of the host computer 105B.

Specifically, the middleware 115B starts the virtual device allocation processing when it performs the processing at step S503 of FIG. 5 (S900).

Subsequently, the middleware 115B performs the same routine as the processing at steps S901 and S902 and the processing at steps S601 and S602.

The middleware 115B thereafter determines whether the virtual device Dev allocated at step S902 is of a mirror attribute (S903).

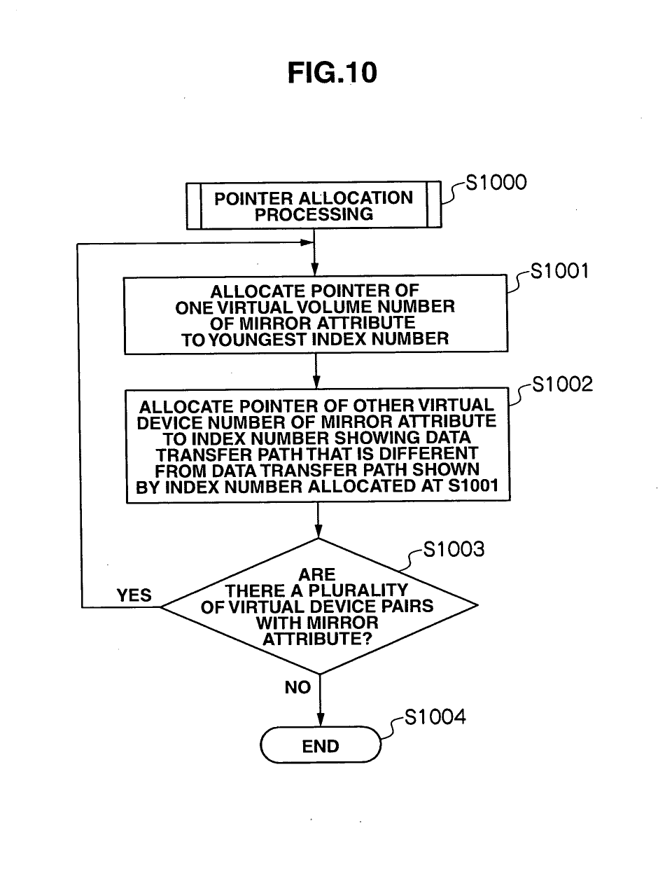

If it is of a mirror attribute (S903: YES), the middleware 115B proceeds to the pointer allocation processing of FIG. 10 (S904).

If it is not a mirror attribute (S903: NO), the middleware 115B allocates the youngest index number among the index groups allocated to the respective virtual devices Dev to the pointer (S905). This is because it is not necessary to use a different appliance as the appliance 140 to be passed through when reading data.

Subsequently, the middleware 115B determines whether there are a plurality of index groups in relation to the same LU number (S906), returns to step S903 when it determines that there is an index group in relation to the same LU number, and continues the processing.

Meanwhile, when the middleware 115B determines that there is no index group in relation to the same LU number (S906: NO), it allocates a different virtual device Dev to the remaining indexed (S907), and then ends this processing (S908).

(2-3) Pointer Allocation Processing

FIG. 10 is a diagram showing a flowchart of pointer allocation processing.

The pointer allocation processing is executed by the path management table module 320 of the middleware 115B based on a pointer allocation program (not shown) in the middleware 115B.

Specifically, when the middleware 115B determines that the virtual device Dev allocated at step S902 is of a mirror attribute (S903: YES), it starts the pointer allocation processing (S1000).

Foremost, the middleware 115B allocates a pointer to the youngest index in one of the virtual devices Dev of a mirror attribute (S1001).

Here, with regard to the term “youngest,” for instance, when there are index numbers 1, 2, the index number 1 having the smallest number is the “youngest” index.

Subsequently, the middleware 115B allocates a pointer to an index that is different from the index allocated at S1001 in the other virtual device Dev of a mirror attribute (S1002).

In FIG. 8, the virtual device numbers 1 and 2 are of a mirror attribute. In addition, the data transfer path of the LU number 1 associated with one virtual device Dev1 is the path of the indexes 1, 2. Accordingly, a pointer is allocated to the youngest index number of 1 at step S1001. The data transfer path of the LU number 2 associated with the other virtual device Dev2 is the path of the indexes 3, 4. A pointer may be allocated to an index that is different from the index 1 allocated with one virtual device Dev1. The pointer allocated to the virtual device Dev1 at step S1001 is the index showing the data transfer path of the host computer port 120Pa-DKC port 165Pa. In other words, the pointer to be allocated to the virtual device Dev2 may be an index showing a data transfer path that is different from the data transfer path of the host computer port 120Pa-DKC port 165Pa. When viewing the path management table 180B, since the index showing the data transfer path of the host computer port 120Pa-DKC port 165Pa is the index 3, here, the pointer is allocated to the index number 4.

Subsequently, the middleware 115B determines whether there are a plurality of pairs of virtual devices of a mirror attribute (S1003), and, when it determines that there are a plurality of such pairs of virtual devices (S1003: YES), it performs the processing at step S1001 once again.

Meanwhile, when the mirror attribute middleware 115B determines that there are no plurality of pairs of virtual devices (S1003: NO), it ends this processing (S1004).

The middleware 115B thereafter proceeds to the processing at S906 described above.

Incidentally, FIG. 9 and FIG. 10 are also effective in the subsequent embodiments in addition to the present embodiment. In other words, the path management table 180 to be used in the subsequent embodiments after this embodiment is created based on the processing of FIG. 9 and FIG. 10.

The storage system 1B shown in FIG. 7 registers the data transfer path of the logical volume LU 171 (corresponds to LU number 1) as the indexes 1, 2, and registers the data transfer path of the logical volume LU 172 (corresponds to LU number 2) as the indexes 3, 4. The virtual devices Dev1, 2 and the pointer are allocated based on the flowchart explained in FIG. 5, FIG. 9 and FIG. 10.

(2-4) Data Guarantee Method

The data guarantee method in the storage system 1B in this embodiment is now explained.

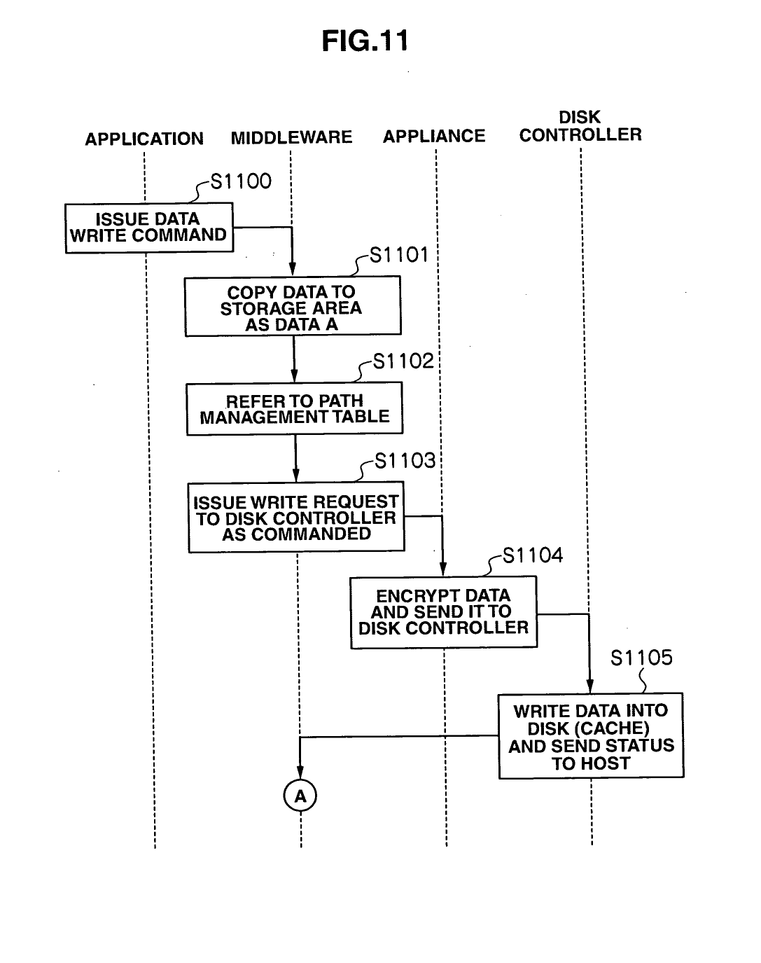

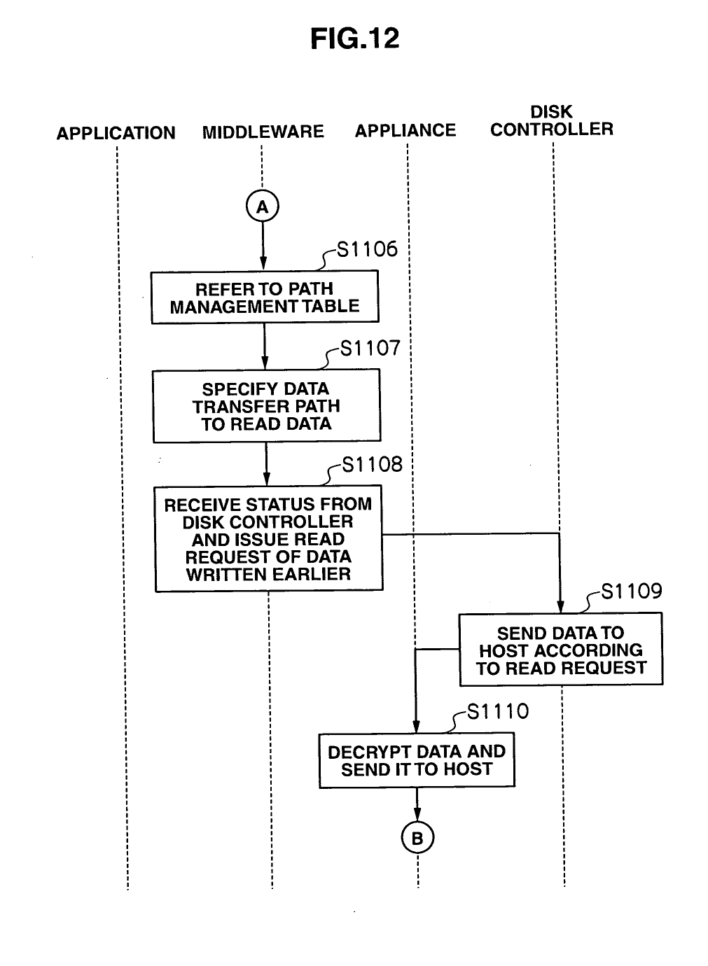

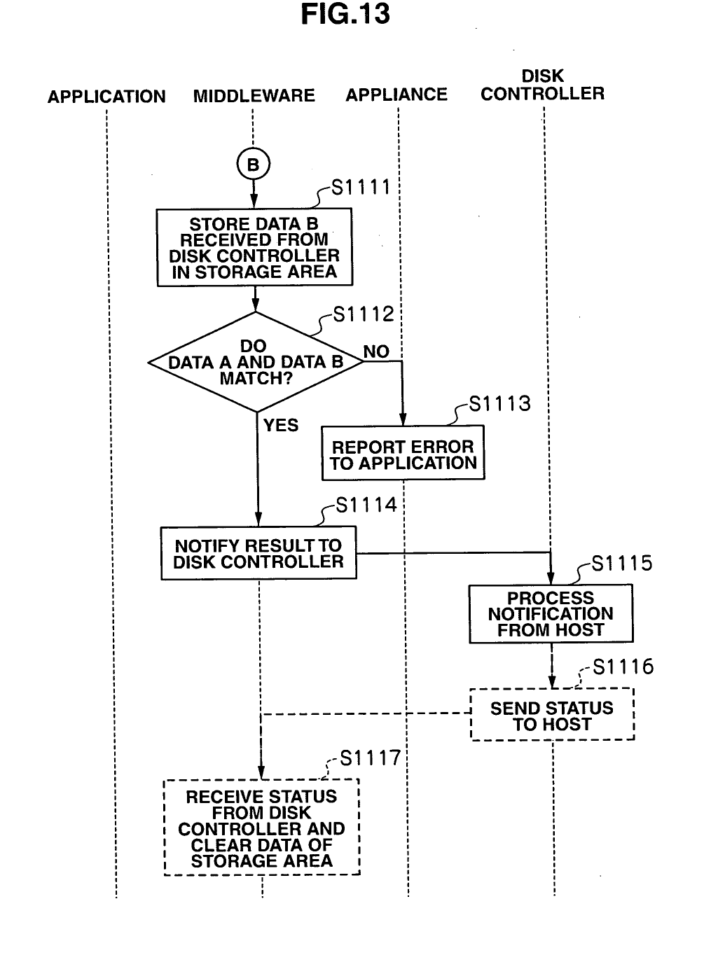

FIG. 11 to FIG. 13 are sequential diagrams of the data guarantee method in the storage system 1B in this embodiment.

When the application 110 commands the middleware 115B to write data into the virtual device Dev1 (S1100), the read-after-write module 305 of the middleware 115B once copies the write data to the storage area 125 (S1101).

For the sake of convenience, the data written into the storage area 125 is referred to as data A.

Subsequently, the middleware 115B refers to the path management table 180B, and confirms the data transfer path to be used next (S1102).

When there is only one data transfer path to the virtual device Dev1, the data transfer path will automatically be that one data transfer path. When there are a plurality of data transfer paths, the middleware 115B refers to the pointer and confirms the data transfer path.

The middleware 115B issues a write request to the disk controller 160B as commanded by the application 110 (S1103).

The appliance 140a encrypts the data and sends it to the disk controller 160B (S1104).

After writing the data into the cache (or disk), the disk controller 160B sends a completion status to the host computer 105 (S1105).

When the middleware 115B receives the completion status from the disk controller 160B, the path management table control module 320 of the middleware 115B refers to the path management table 180B (S1106), and specifies the data transfer path to read the data (S1107). Specifically, the data transfer path of the index indicated by the pointer in the pointer field 130 of the path management table 180B is specified.

The read-after-write module 305 of the middleware 115B uses the data transfer path decided at S1107 and issues a read request of the written data to the disk controller 160B (S1108).

The disk controller 160B sends data designated with the read request to the host computer 105 (S1109).

The appliance 140a decrypts the data and sends it to the host computer 105 (S1110).

The middleware 115B stores the data received from the disk controller 160B in the storage area 125 (S1111).

For the sake of convenience, the data stored in the storage area at S1111 is referred to as data B.

The data comparison module 310 of the middleware 115B reads and compares the data A and the data B stored in the storage area 125 (S1112).

The data comparison module 310 of the middleware 115B proceeds to step S1114 when the data A and the data B stored in the storage area 125 coincide (S1112: YES).

Meanwhile, when the data A and the data B stored in the storage area 125 do not coincide based on the data comparison module 310 of the middleware 115B (S1112: NO), the middleware 115B reports an error to the application 110 (S1113). At this moment, the data A and the data B will not coincide if there is a malfunction in the encryption processing or the decryption processing of the appliance 140a. In other words, it is possible to detect the abnormality of data at steps S1112 and S1113.

Basically, although it is possible to detect the abnormality of data with the foregoing processing, if a malfunction in the encryption processing and such data is decrypted, this data will be different from the original data. Under an environment where a plurality of host computers are sharing the data (actually the logical volume), there is fear that other host computers will read this data. Thus, a measure is taken so that this data cannot be read until it is confirmed that the data has been guaranteed in the processing at step S1113.

In order to notify that the data integrity has been guaranteed, the message transmission/reception module 315 of the middleware 115B notifies such data integrity to the disk controller 160B (S1114).

The disk controller 160B receives the notice from the message transmission/reception module 315 (S1115), and confirms the writing of this data.

Incidentally, for the purpose of deleting the data A and data B stored in the storage area 125 of the host computer 105B, the disk controller 160B may send a reception reply to the read-after-write module 305 (S1116) to delete the data A and the data B (S1117).

The data can be guaranteed regarding the virtual device Dev2 with the same method described above.

(2-5) Effect of First Embodiment

According to the present embodiment, by using the appliance as a device having a function of encrypting or decrypting data, since the data caused by the malfunction of the encryption processing performed by the host computer using the appliance can be detected during the reading of data, data can be reliably guaranteed in a storage system that supports the encryption function of data to be stored.

### (3) SECOND EMBODIMENT

(3-1) System Configuration

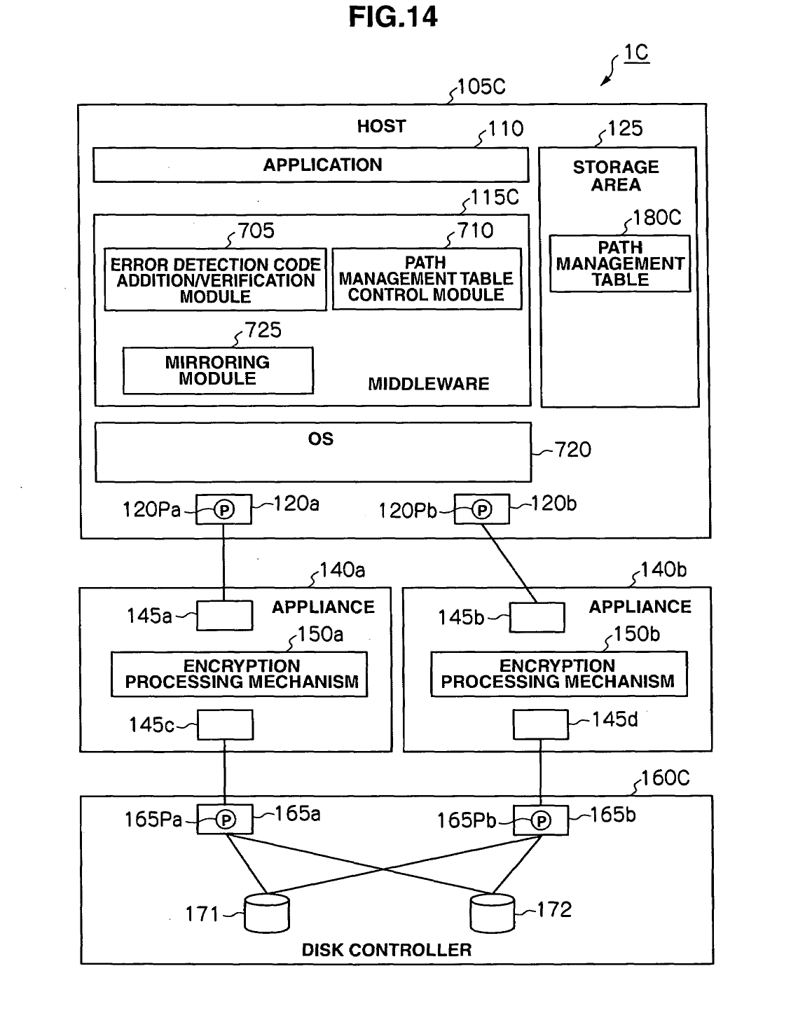

FIG. 14 is a diagram showing the configuration of the storage system according to a second embodiment. FIG. 14 shows the storage system 1C in this embodiment.

In this embodiment, in order to guarantee the data integrity of the storage system 1C comprising an encryption function, the host computer 105C adds a error detection code to the data and writes it into the disk controller 160C. Then, the host computer 105C verifies the error detection code when this data is read to guarantee the data completeness. If the error detection code created from the read data and the initially added error detection code do not coincide, it is deemed that a malfunction occurred in the encryption processing or the decryption processing.

Incidentally, the storage system 1C shown in FIG. 14 is basically the same as the storage system 1A explained in FIG. 1, and the same reference numerals are given to the same constituent elements. Only the constituent elements that are different from the storage system 1A explained in FIG. 1 are explained below.

The error detection code addition/verification module 705 comprises a function of adding a error detection code to the data to be written into the logical volume of the disk controller 160C by the application 110, and a function of comparing the error detection code newly created from the data read from the disk controller 160C and the initially added error detection code.

The path management table control module 710 is the same as the path management table control module 320 of the first embodiment.

An OS (Operating System) 720 is basic software that manages the various resources of the host computer 105C to enable the application 110 to use the various resources.

When the mirroring module 725 writes the write data from the application 110 into the mirrored logical volume of the disk controller 160C, or was not able to read the data stored in one of the mirrored logical volumes in response to the data read request, it reads the data from the other logical volume. In this embodiment, the mirrored pair of logical volumes will be the logical volumes LU 171, LU 172.

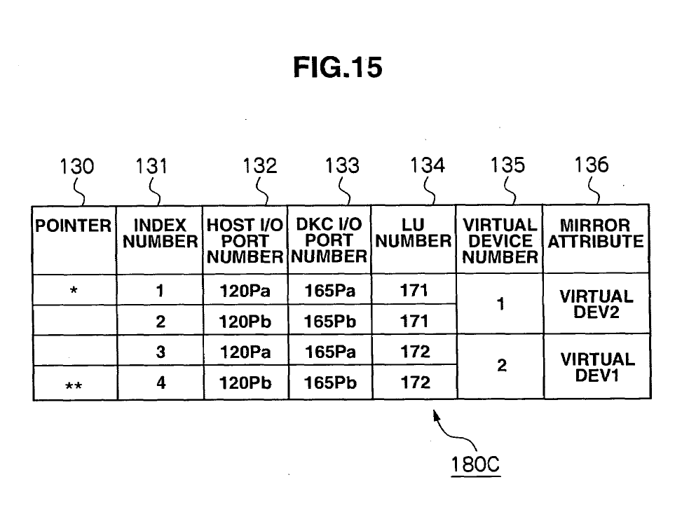

FIG. 15 is a diagram showing an example of the path management table 180C in this embodiment. The items of the path management table 180C that are the same as the items of the path management tables 180, 180B explained above are given the same reference numerals.

When viewing FIG. 14, since the logical volumes LU 171, LU 172 respectively have two data communication paths, there are a total of four indexes showing the data transfer path of the path management table 180C.

The logical volume LU 171 can be accessed from the host computer port 120Pa-DKC port 165Pa and the host computer port 120Pb-DKC port 165Pb. The logical volume LU 172 can also be accessed from the same data transfer paths as the logical volume LU 171.

Accordingly, based on the path management table creation flow of FIG. 5 and FIG. 9, the virtual device Dev1 is allocated to the indexes 1, 2 and the virtual device Dev2 is allocated to the indexes 3, 4. And, since the logical volume LU is mirrored, the virtual device Dev1 and the virtual device Dev2 are registered as a mirror attribute.

(3-2) Data Guarantee Method

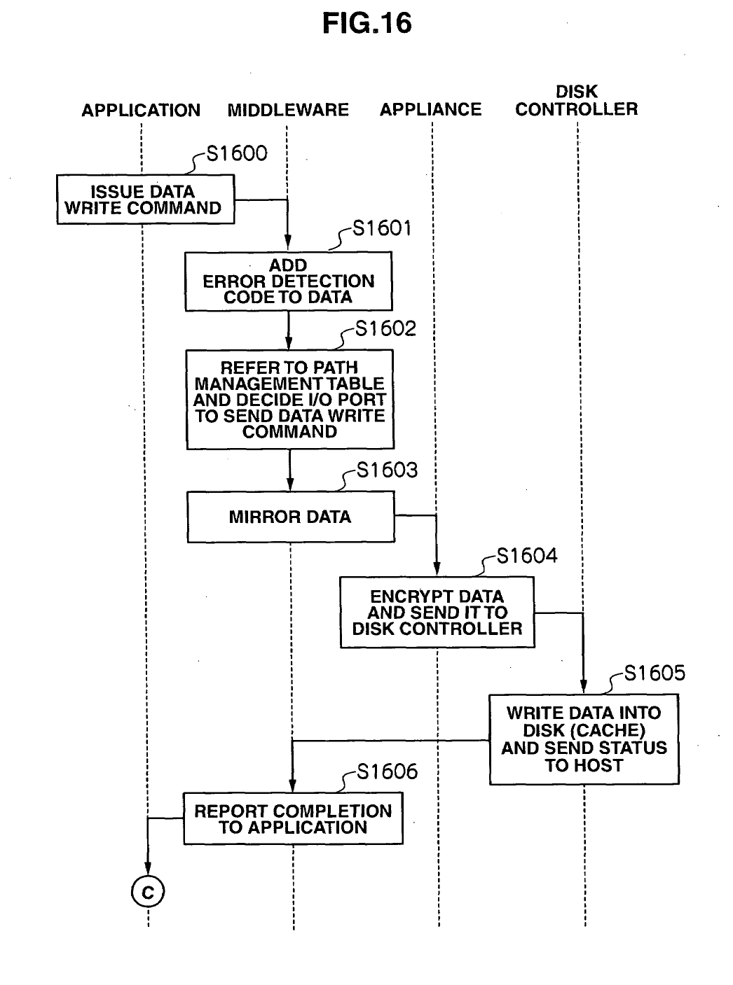

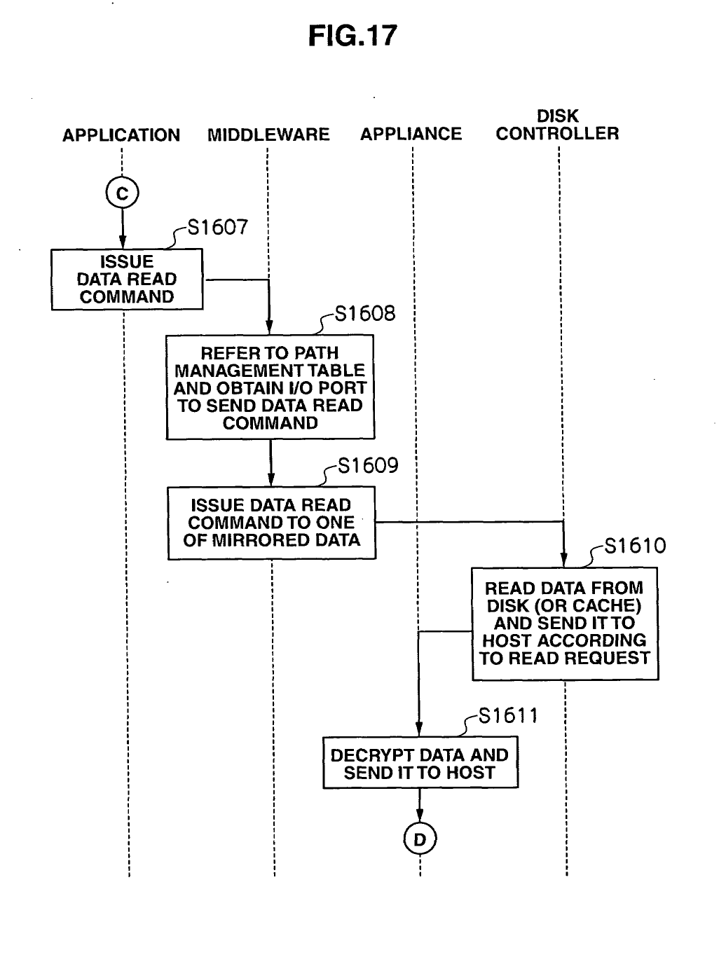

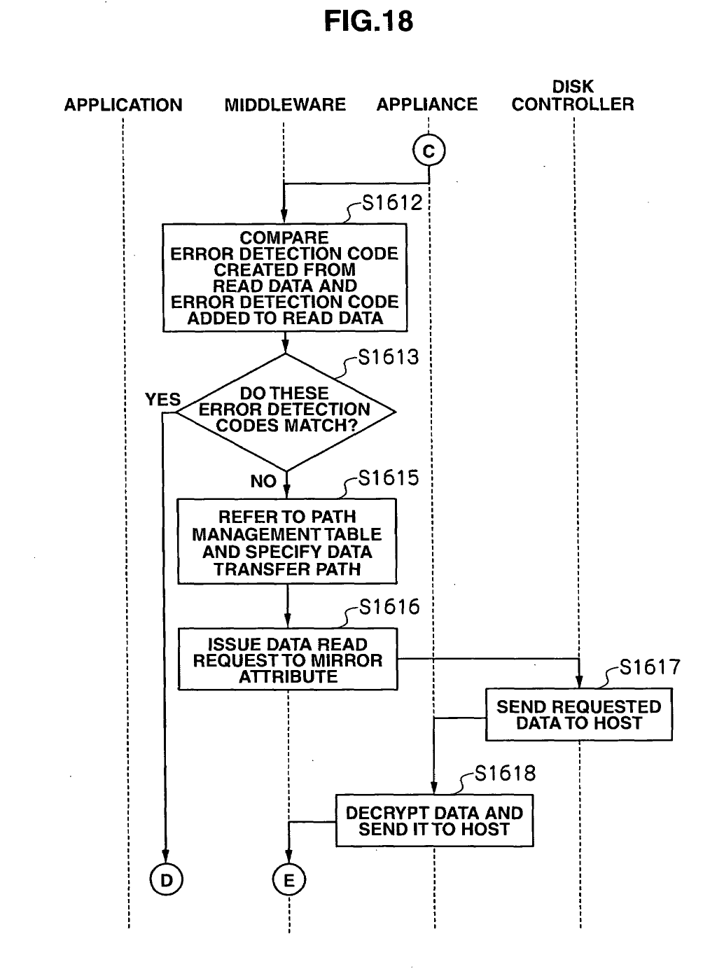

FIG. 16 to FIG. 19 are sequential diagrams of the data guarantee method of this embodiment.

Specifically, foremost, when the application 110 commands the writing of data into the virtual device Dev1 (S1600), the error detection code addition/verification module 705 of the middleware 115C adds a error detection code to the write data (S1601). The path management table control module 710 refers to the path management table 180C, and confirms the data transfer path to be used next (S1602). In other words, the path management table control module 710 specifies the I/O port to send the data write command to the disk controller 160C (S1602).

Subsequently, the mirroring module 725 of the middleware 115C mirrors the write data to be written into a different virtual device together with the error detection code added to such write data (S1603). Here, the different virtual device is the virtual device Dev2 as a mirror attribute. The data transfer path here is the data transfer path confirmed at step S1602.

The appliances 140a, 140b respectively encrypt the write data and the error detection code added to the write data, and sends them to the disk controller 160C (S1604).

The disk controller 160C writes the encrypted write data and the error detection code received from the appliance 140a, 140b into the cache (or disk), and sends the completion status to the host computer 105C (S1605).

When the middleware 115C reports the completion status to the application 110 (S1606), the application 110 receives the completion status of the disk controller 160C and ends the data write processing.

Meanwhile, when the application 110 commands the reading of data written with the foregoing data write processing from the virtual device Dev1 (S1607), the path management table control module 715 of the middleware 115C refers to the path management table 180C and obtains the data transfer path to send the data read command (S1608).

The middleware 115C sends the data read command according to the data transfer path obtained at step S1607 (S1609). For instance, when viewing the path management table 180C of FIG. 15, the index 1 is indicating the virtual device Dev1. Thus, the data transfer path will be the path of the index 1.

The disk controller 160C sends the data stored in the cache (or disk) to the host computer 105C according to the data read command sent at step S1608 (S1610).

The appliance 140a decrypts the encrypted data and error detection code and sends them to the host computer 105C (S1611).

The error detection code addition/verification module 705 of the middleware 115C compares the error detection code created from the data received from the disk controller 160C and the error detection code added to the data (S1612).

The error detection code addition/verification module 705 of the middleware 115C determines whether both error detection codes coincide (S1613).

If the error detection codes coincide as a result of comparison (S1613: YES), the error detection code addition/verification module 705 delivers data to the application 110 since this means that it is guaranteed that no malfunction has occurred in the encryption processing or the decryption processing by the appliance 140a(S1614).

When the error detection code addition/verification module 705 determines that the error detection codes do not coincide (S1613: NO), the path management table control module 710 refers to the path management table 180C for reading the mirrored data, and specifies the data transfer path to read the mirrored data (S1615).

The middleware 115 uses the data transfer path specified at step S1607, and issues a data read request to a logical volume with a mirror attribute (S1616). For example, when viewing the path management table 180C of FIG. 15, the index 4 is indicating the virtual device Dev2. Thus, the data transfer path will be the path of the index 4.

The disk controller 160C sends the data to the host computer 105C according to the data read request (S1617).

The appliance 140b decrypts the encrypted data and error detection code and sends them to the host computer 105C (S1618).

The error detection code addition/verification module 705 of the middleware 115C, as at step S1611, compares the error detection code created from the data received from the disk controller 160C and the error detection code added to the data (S1619).

The error detection code addition/verification module 705 of the middleware 115C determines whether both error detection codes coincide (S1620).

If the error detection codes coincide as a result of comparison (S1620: YES), the error detection code addition/verification module 705 delivers data to the application 110 since this means that it is guaranteed that no malfunction has occurred in the encryption processing or the decryption processing by the appliance 140b (S1613).

When the error detection code addition/verification module 705 determines that the error detection codes do not coincide (S1620: NO), it reports an error to the application 110 (S1621).

Finally, the path management table control module 710 of the middleware 110C implements pointer movement processing (S1622), and ends this sequence (S1623).

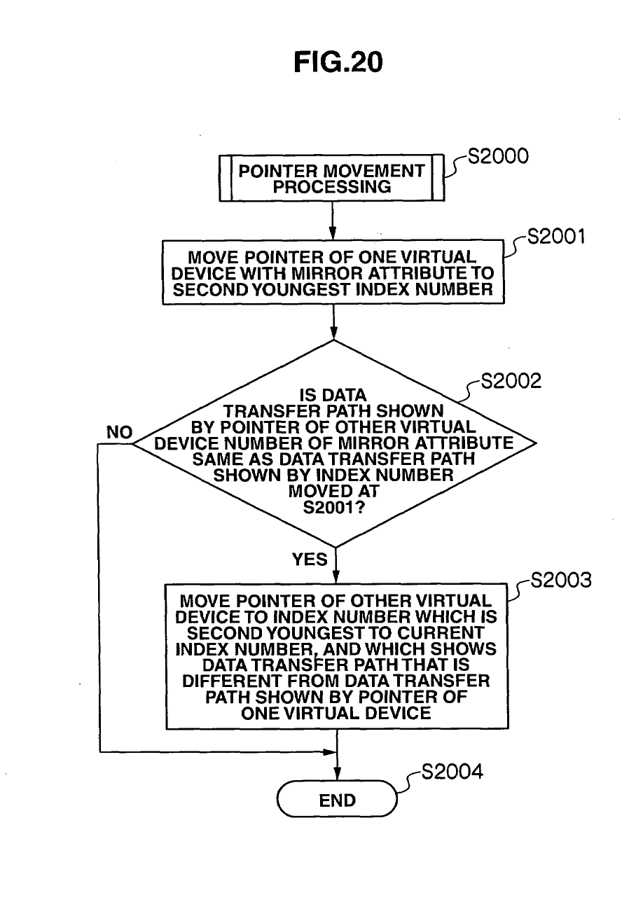

FIG. 20 is a flowchart showing the movement processing of the pointer of the path management table 180C.

The pointer movement processing is executed by the path management table module 710 of the middleware 115B based on the pointer migration program (not shown) in the middleware 115B.

Specifically, when the error detection code addition/verification module 705 delivers data to the application 110 (S1614), or reports an error to the application 110 (S1621), the path management table control module 710 starts the pointer movement processing (S2000).

Foremost, the path management table control module 710 refers to the path management table 180C, and moves the pointer to the next youngest index after the index shown with the current pointer of one virtual device Dev that is a mirror attribute (S2001).

Subsequently, the path management table control module 710 determines whether the data transfer path of the index shown with the current pointer of the other virtual device Dev as a mirror attribute is the same as the data transfer path of the index shown with the pointer moved at step S2001 (S2002).

If the data transfer paths are the same, the mirrored data will use the same data transfer path. Thus, it is necessary to avoid using the same data transfer path.

When the path management table control module 710 determines that they are the same data transfer paths (S2002: YES), it moves the pointer location of the other virtual device. Dev to an index number that is the second youngest after the index shown with the current pointer, and which shows a data transfer path that is different from the data transfer path shown by the pointer of the one virtual device (S2003).

For example, with the path management table 180C of FIG. 15, although the current pointer of the virtual device Dev1 indicates the index 2, since there are only two data transfers (indexes 1, 2) regarding the virtual device Dev1, the destination of the next pointer will be the index number 1. Meanwhile, regarding the virtual device Dev2 as a mirror attribute, the destination of the pointer will be the index number 4 in order to use a position that is different from the position of the pointer of the virtual device Dev1.

When the pointer of the destination is decided, the path management table control module 710 ends this processing (S2004).

When the path management table control module 710 determines that they are not the same data transfer paths (S2002: NO), it directly ends this processing (S2004).

Incidentally, although the destination of the pointer was made to be the second youngest index after the index indicating the current pointer at steps S2001 and S2003, the present invention is not limited thereto.

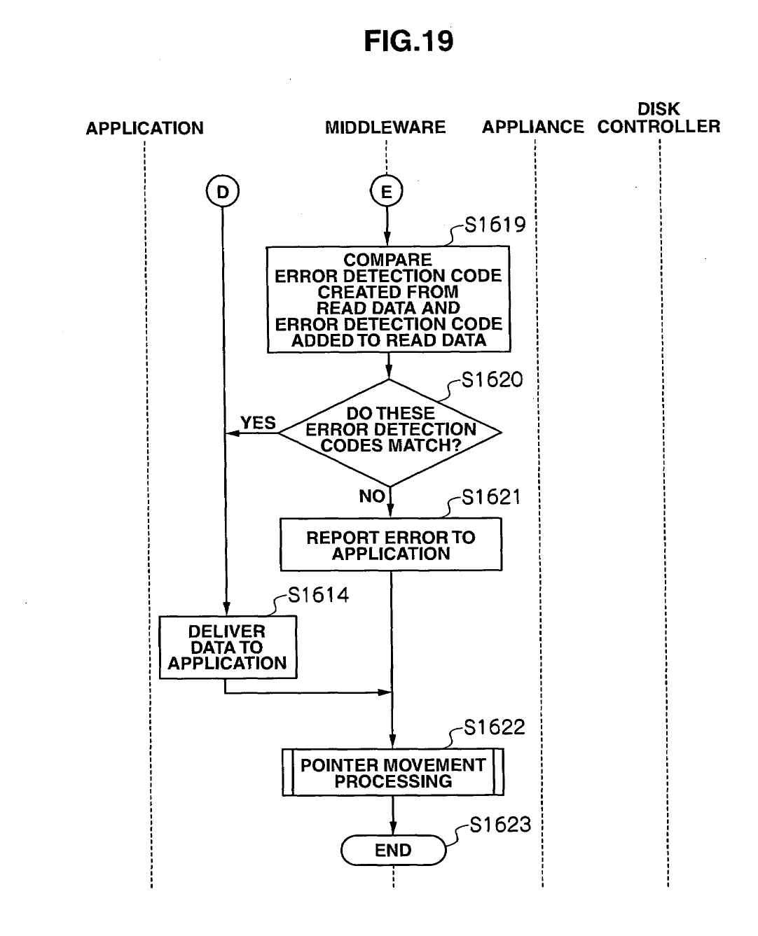

Further, upon implementing the pointer movement processing, for instance, when the determination is NO at step S1613 at FIG. 19; in other words, when it is possible to deem that a malfunction occurred in the encryption processing or the decryption processing of the appliance 140a, the appliance 140a should not be used thereafter. Accordingly, the path management table control module 710 should not select a data transfer path that passes through the appliance 140a. When there are only two appliances as in the second embodiment, there is no choice but to temporarily pass through the other normal appliance 140b. Nevertheless, by replacing the appliance 140a determined as being defective by the host computer 105C with a new appliance, the data can be guaranteed once again by using a physically different data transfer path.

(3-3) Effect of Second Embodiment

According to the present embodiment, by using the appliance as a device having a function of encrypting or decrypting data, since the data caused by the malfunction of the encryption processing performed by the host computer using the appliance can be detected during the reading of data, data can be reliably guaranteed in a storage system that supports the encryption function of data to be stored.

Further, since this embodiment adopts a mirror configuration, data can be reliably guaranteed by sending data in another virtual device to the host computer through a path that is different that the path for transferring data in one virtual device.

### (4) THIRD EMBODIMENT

(4-1) System Configuration

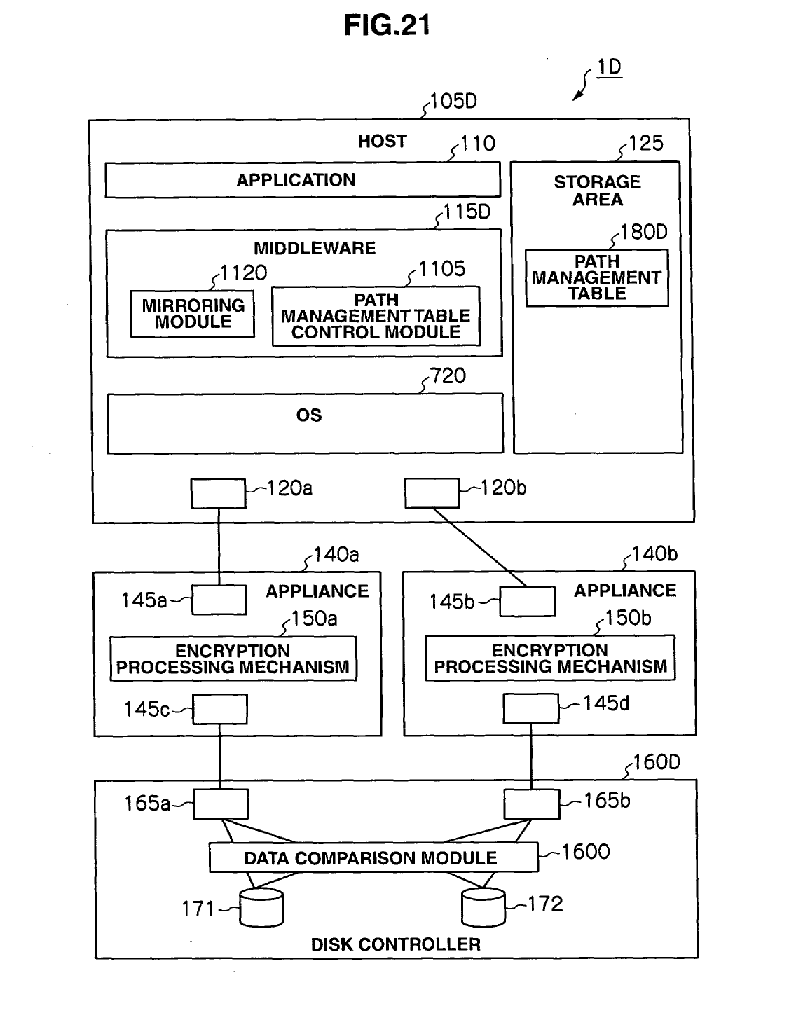

FIG. 21 is a diagram showing the configuration of the storage system according to a third embodiment. FIG. 21 shows the storage system 1D in this embodiment.

In this embodiment, in order to guarantee the data completeness of the storage system comprising an encryption function, the host computer mirrors and stores the data in different logical volumes. Then, the storage controller guarantees the data completeness by comparing the mirrored data.

Incidentally, the storage system 1D shown in FIG. 21 is basically the same as the storage system 1A explained in FIG. 1, and the same reference numerals are given to the same constituent elements. Only the constituent elements that are different from the storage system 1A explained in FIG. 1 are explained below.

The path management table control module 1105 and the mirroring module 1120 are the same as the path management table control module 710 and the mirroring module 725 in the second embodiment.

The path management table 180D is the same as the path management table 180B explained in the first embodiment.

The data comparison module 1600 is provided in the disk controller 160D, and compares the data sent from the host computer 105D and encrypted by the appliances 140a, 140b stored in the mirrored logical volumes LU 171, 172.

(4-2) Data Guarantee Method

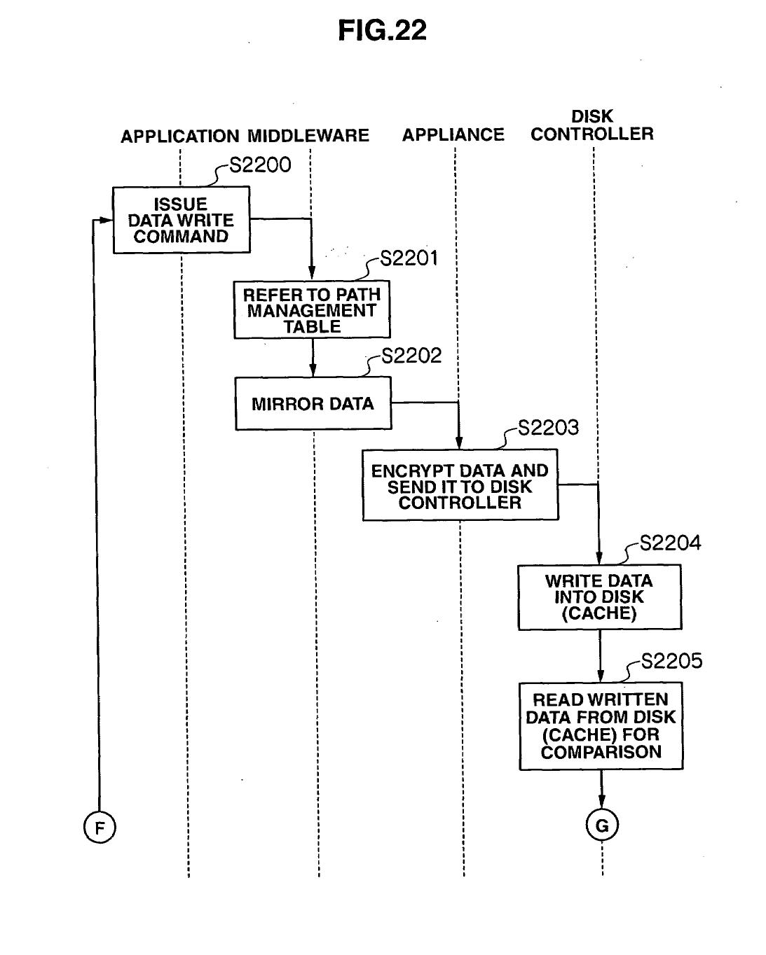

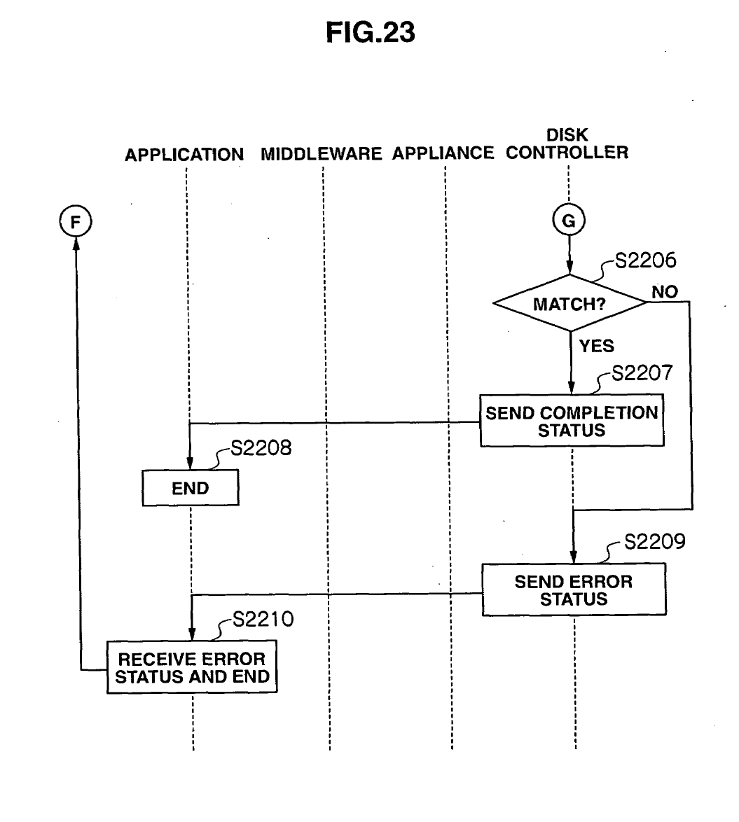

FIG. 22 and FIG. 23 are sequential diagrams of the data guarantee method in this embodiment.

Specifically, foremost, when the application 110 receives a data write command (S2200), the mirroring module 1120 refers to the path management table 180D and specifies the data transfer path (S2201). This specification method has been explained with reference to FIG. 2 and FIG. 7, and the explanation thereof is hereby omitted.

The mirroring module 1120 of the middleware 115D mirrors the data, and writes such data into separate logical volumes (S2202).

The appliances 140a, 140b respectively encrypt the data, and send it to the disk controller 160D (S2203).

The disk controller 160D writes the respectively encrypted data sent from the appliances 140a, 140b into the logical volumes LU 171, 172 or the cache (S2204). Then, based on a command from the processor (not shown) of the disk controller 160D, the data comparison module 1600 compares the respectively encrypted data written into the logical volumes LU 171, 172 or the cache (S2205).

The data comparison module 1600 of the disk controller 160D determines whether the respectively encrypted data coincide (S2206).

If a malfunction had occurred during the encryption processing of one of the appliances 140a, 140b, since the comparison results at step S2206 will not coincide, data arising from the malfunction of the appliance 140 can be detected.

When the data comparison module 1600 of the disk controller 160D determines that the respectively encrypted data coincide (S2206: YES), it sends a completion status to the host computer 105D (S2207).

The application 110 of the host computer 105D ends this sequence upon receiving the completion status (S2208).

Meanwhile, when the data comparison module 1600 of the disk controller 160D determines that the respectively encrypted data do not coincide (S2206: NO), it sends an error status to the host computer 105D (S2209).

The application 110 of the host computer 105D returns to step S2000 once again upon receiving the error status (S2210), and issues the rewrite command of data.

Like this, according to the status from the disk controller 160D, the host computer 105D proceeds to the subsequent processing, resends the data write command or proceeds to the failure processing set forth by the application after receiving the completion status.

(4-3) Effect of Third Embodiment

According to the present embodiment, by using the appliance as a device having a function of encrypting or decrypting data, since the data caused by the malfunction of the encryption processing performed by the host computer using the appliance can be detected during the reading of data, data can be reliably guaranteed in a storage system that supports the encryption function of data to be stored.

### (5) FOURTH EMBODIMENT

(5-1) System Configuration

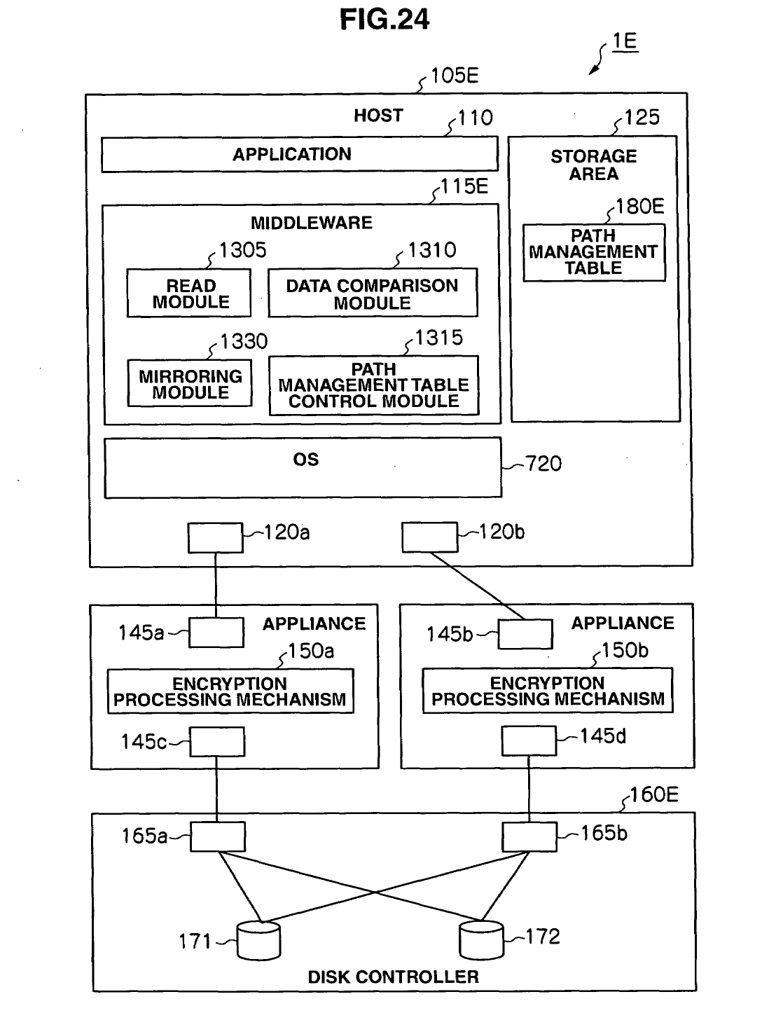

FIG. 24 is a diagram showing the configuration of the storage system according to a fourth embodiment. FIG. 24 shows the storage system 1E in this embodiment.

In this embodiment, in order to guarantee the data completeness of the storage system comprising an encryption function, the host computer 105E mirrors and stores the data in the respective logical volumes LU 171, 172. And, when reading the data, the host computer 105E guarantees the data integrity by simultaneously reading the mirrored data and comparing such data. If the data do not coincide as a result of the comparison, it is deemed that a malfunction occurred in the encryption processing or the decryption processing.

Incidentally, the storage system 1E shown in FIG. 24 is basically the same as the storage system 1A explained in FIG. 1, and the same reference numerals are given to the same constituent elements. Only the constituent elements that are different from the storage system 1A explained in FIG. 1 are explained below.

The read module 1305 commands the reading of both mirrored data when the application 110 requests the reading of data.

Normally, when writing data with the mirroring function, data is written into the respective logical volumes LU 171, 172, but data is read only from one of the logical volumes.

In order to compare data on the side of the host computer 105E as in the fourth embodiment, since both of the mirrored data are required, the read module 1305 is provided.

The data comparison module 1310 has the same function as the data comparison module 160 explained in the third embodiment.

The path management table control module 1315, the mirroring module 1330, and the path management table 180E are the same as the path management table control module 710, the mirroring module 725, and the path management table 180C explained in the second embodiment.

(5-2) Data Guarantee Method

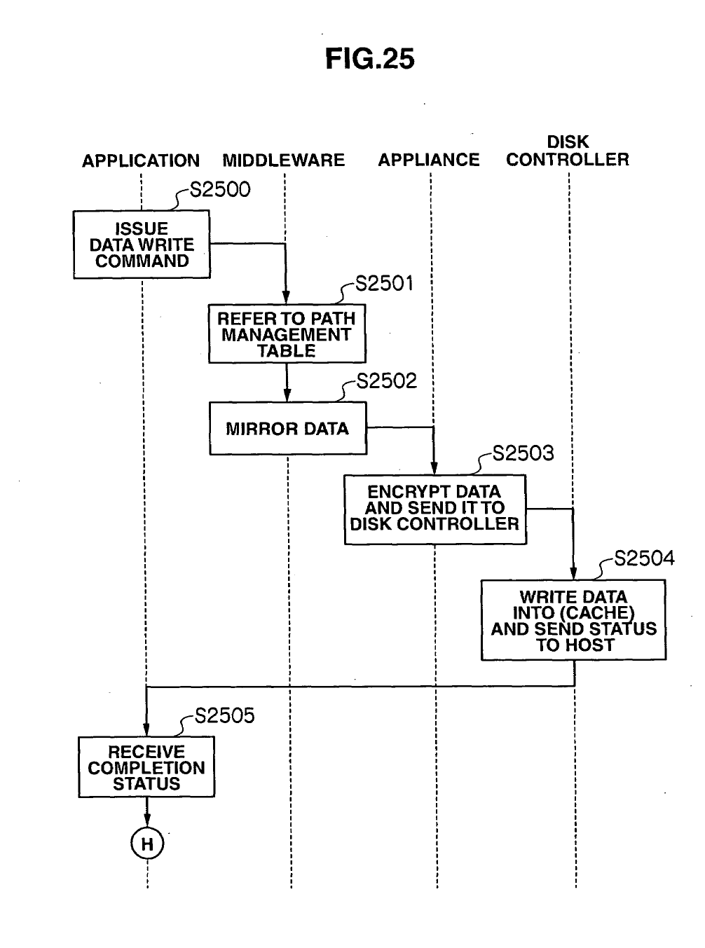

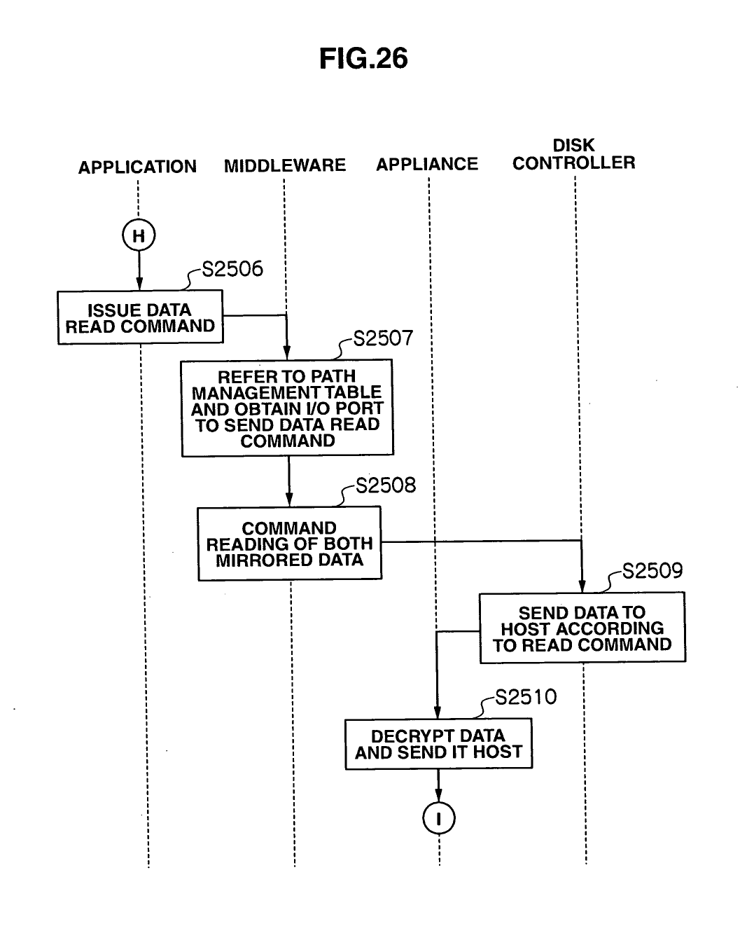

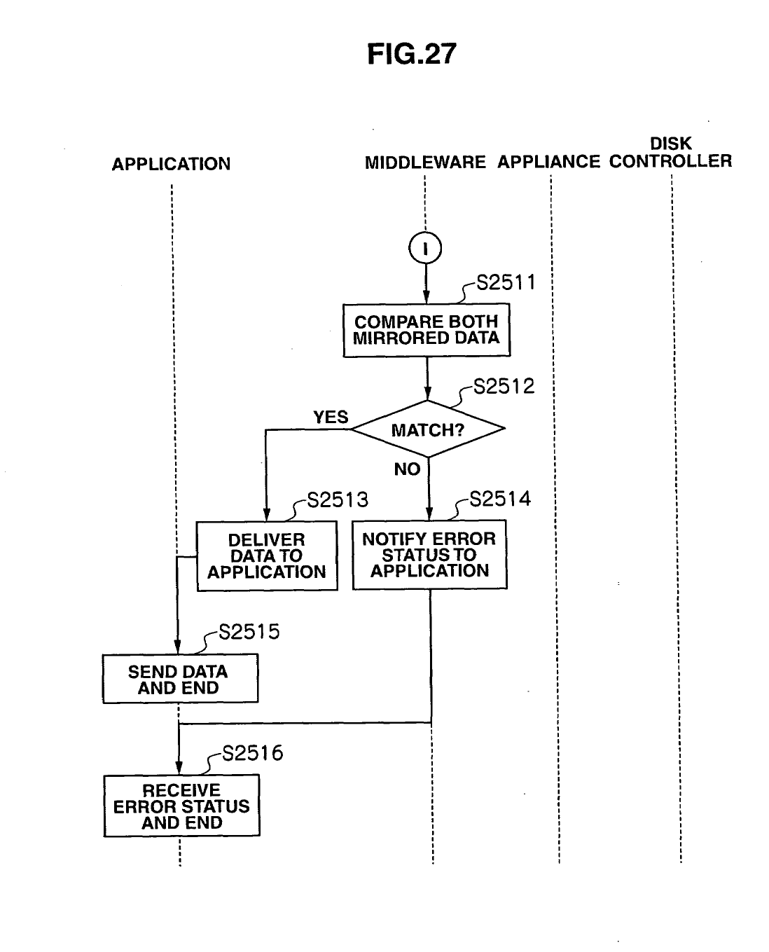

FIG. 25 to FIG. 27 are sequential diagrams of the data guarantee method in this embodiment.

Specifically, foremost, the processing from step S2500 to step S2503 is performed according to the same routine as the processing from step S2200 to step S2203.

The disk controller 160E writes the encrypted data sent from the appliances 140a, 140b into the cache (or logical volume LU), and sends a completion status to the host computer 105E (S2504).

The host computer 105E receives the completion status from the disk controller 160E, and then ends this data write processing (S2505).

After the data write processing is complete, at an arbitrary timing, the application 110 issues a read command for reading the data written at step S2500 (S2506).

When the path control table control module 1315.of the middleware 115E receives the data read command, it refers to the path management table 180E, and obtains the data transfer path to send the data read command (S2507). Here, the logical volumes LU 171, 172 storing both mirrored data will be targets.

When the read module 1305 of the middleware 115 issues a read command for reading both of the mirrored data based on the data transfer path (S2508), the disk controller 160E sends the data to the host computer 105E according to such command (S2509).

The appliances 140a, 140b decrypt the data from the disk controller 160E and send such data to the host computer 105E (S2510).

The data comparison module 1310 of the middleware 115E compares both data received from the appliances 140a, 140b (S2511), and determines whether both data coincide (S2512).

When the data comparison module 1310 determines that both data coincide (S2512: YES), it delivers one data to the application 110 (S2513), and ends this sequence when the application 110 receives the data (S2515).

Meanwhile, when the data comparison module 1310 determines that both data do not coincide (S2512: NO), it sends an error status to the host computer 105E (S2514), and ends this sequence when the application 110 receives the error status (S2516).

(5-3) Effect of Fourth Embodiment

According to the present embodiment, by using the appliance as a device having a function of encrypting or decrypting data, since the data caused by the malfunction of the encryption processing performed by the host computer using the appliance can be detected during the reading of data, data can be reliably guaranteed in a storage system that supports the encryption function of data to be stored.

Further, since this embodiment adopts a mirror configuration, data can be reliably guaranteed by sending data in another virtual device to the host computer through a path that is different that the path for transferring data in one virtual device.

### (6) FIFTH EMBODIMENT

(6-1) System Configuration

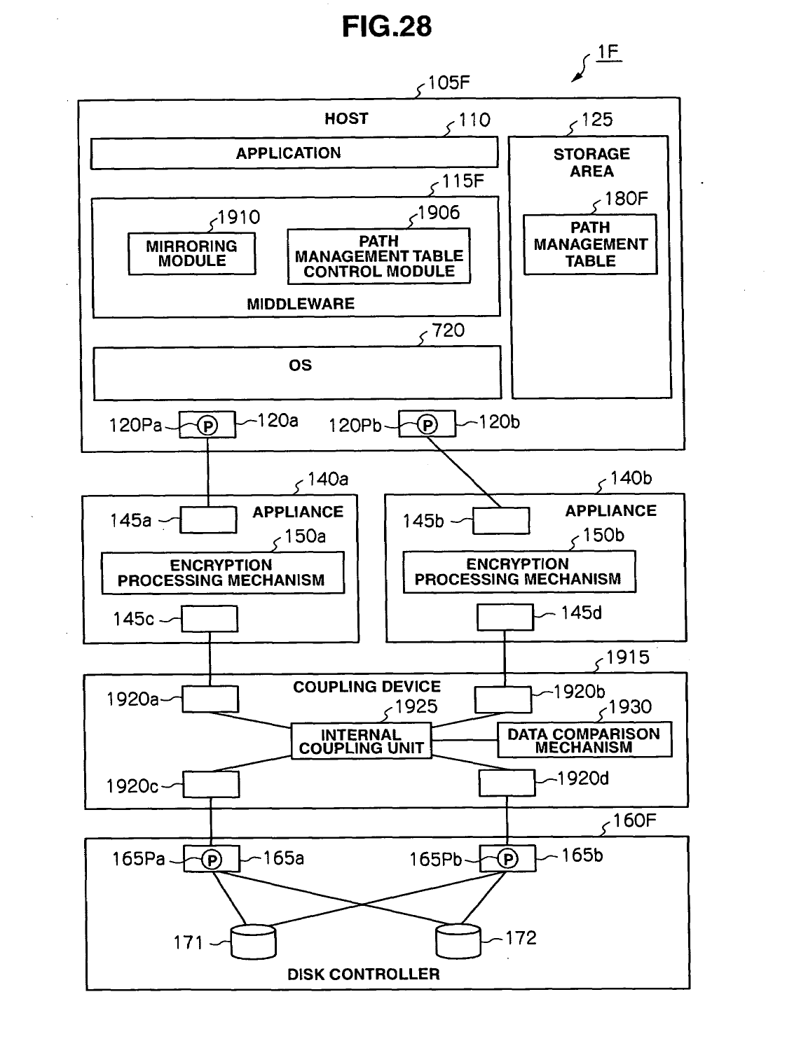

FIG. 28 is a diagram showing the configuration of the storage system in a fifth embodiment. FIG. 28 shows the storage system 1F in this embodiment.

In this embodiment, in order to guarantee the data completeness of the storage system comprising an encryption function, the host computer mirrors and stores the data in different logical volumes. Then, the data integrity is guaranteed by comparing the mirrored data in a coupling device configuring the data transfer path between the host computer and the disk controller.

Incidentally, the storage system 1E shown in FIG. 28 is basically the same as the storage system 1A explained in FIG. 1, and the same reference numerals are given to the same constituent elements. Only the constituent elements that are different from the storage system 1A explained in FIG. 1 are explained below.

The mirroring module 1610 is the same as the mirroring module 725 explained in the second embodiment.

The data comparison mechanism 1930 connected to the internal coupling unit 1925 of the coupling device 1915 is equipped with the same function as the data comparison module 310 explained in the first embodiment.

The coupling device 1915 is a component for mutually coupling the appliances 140a, 140b and the DKC port 165P of the disk controller 160F. In other words, the appliance 140a is able to access both DKC ports 165Pa, 165Pb of the disk controller 160. The appliance 140b is also able to access both DKC ports 165Pa, 165Pb of the disk controller 160.

In the foregoing embodiments, although the appliance 140 was interposed between the host computer port 120P and the DKC port 160P of the disk controller 160F, it was basically a direct connection. Nevertheless, when the coupling device 1915 exists midway as in the fifth embodiment, the data transfer path is handled differently. In other words, it is necessary to also give consideration to the correspondence relation of the I/O port in the coupling device 1915.

(6-2) Path Management Table

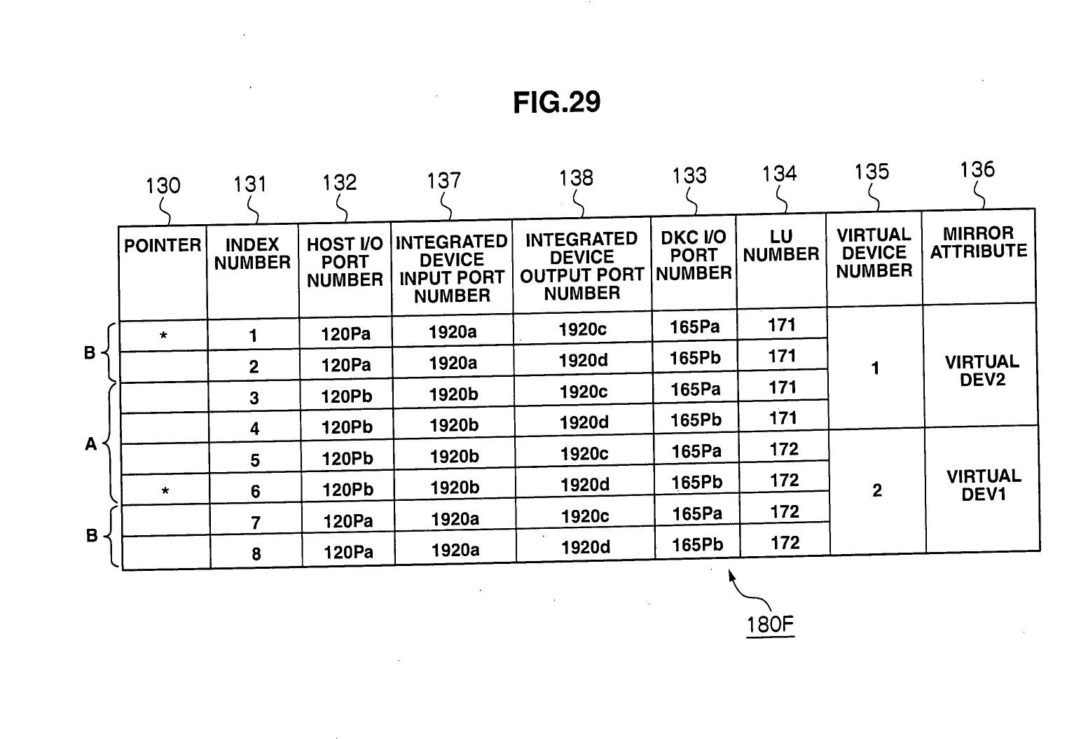

FIG. 29 is a chart showing an example of the path management table 180F in this embodiment.

The difference from the path management tables 180 to 180E explained in the foregoing embodiments is that a “coupling device input port” field 137 and a “coupling device output port” field 138 have been provided.

The “coupling device input port” field 137 shows the ports 1920a, 1920b in which the coupling device 1915 is connected to the side of the host computer 105F.

The “coupling device output port” field 138 shows the ports 1920c, 1920d in which the coupling device 1915 is connected to the side of the disk controller 160F.

According to the present embodiment, there are four data transfer paths to the logical volume LU 171 associated with the virtual device Dev1. There are also four data transfer paths to the logical volume LU 172 associated with the virtual device Dev2.

Further, it is also necessary to give consideration to the appliance 140 existing in the respective data transfer paths of the path management table 180F. The data transfer path A (indexes 3 to 6) shown in FIG. 29 passes through the appliance 140a. The data transfer path B (indexes 1, 2, 7, 8) shown in FIG. 29 passes through the appliance 140b.

Consideration must be given to the above when passing the respectively mirrored data through separate appliances 140a, 140b.

(6-3) Data Guarantee Method

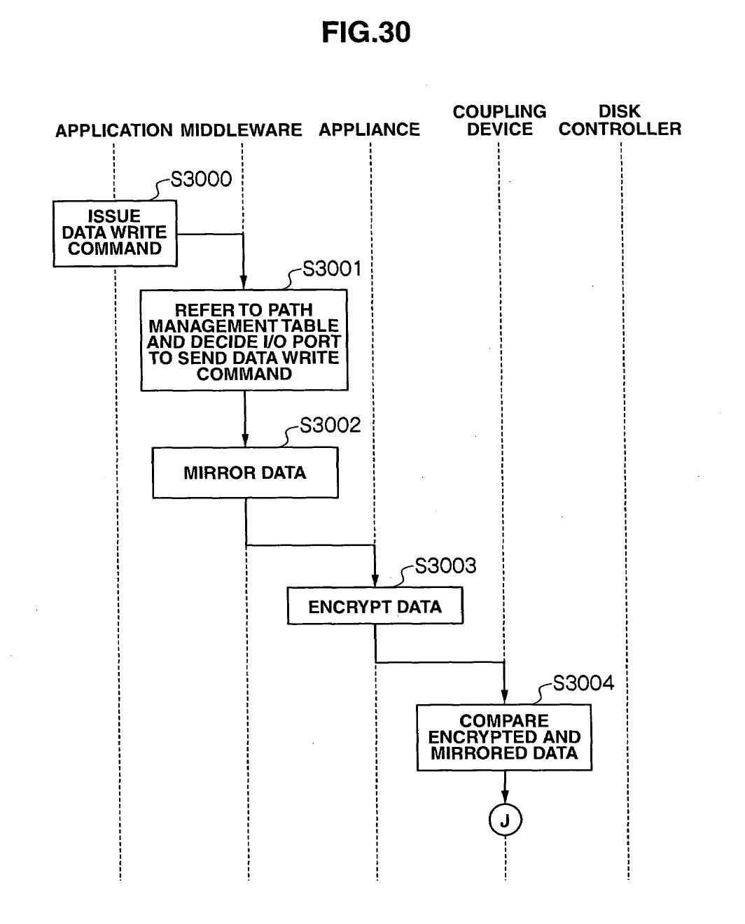

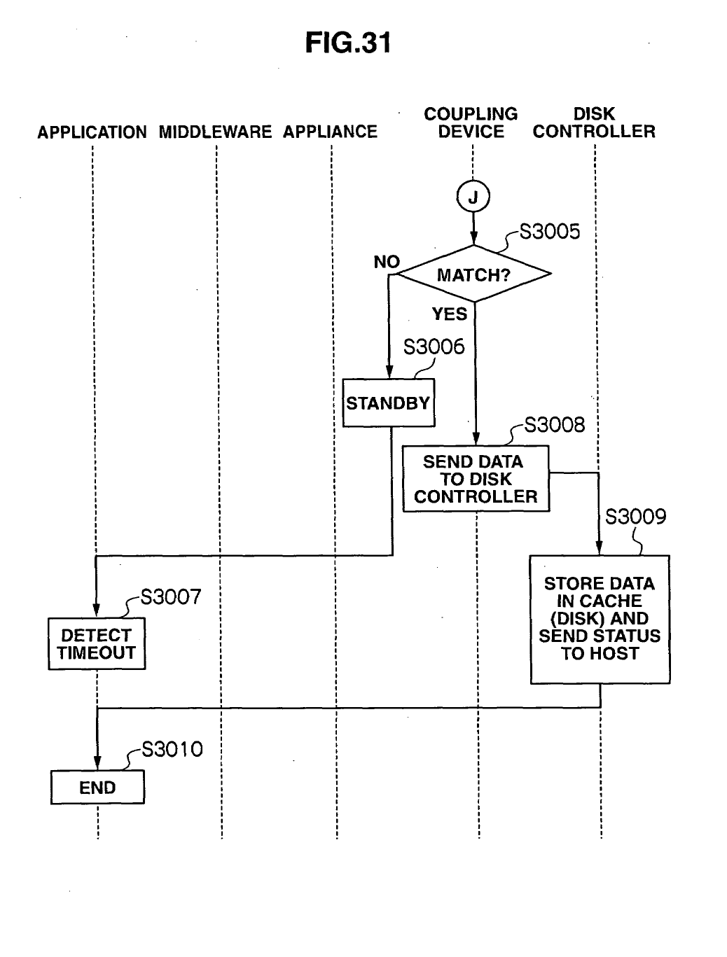

FIG. 30 and FIG. 31 are diagrams showing the flowchart of the data guarantee method in this embodiment.

Specifically, foremost, the processing from step S3000 to step S3002 is performed according to the same routine as the processing from step S2200 to step S2202.

When the appliances 140a, 140b encrypt the data (S3003), they send the encrypted data to the coupling device 1915 with the respective decided data transfer paths (for example, indexes 1, 6).

The data comparison mechanism 1930 of the coupling device 1915 compares the respectively encrypted data (S3004).

The data comparison mechanism 1930 determines whether the respectively encrypted data coincide (S3005).

When the data comparison mechanism 1930 determines that the respectively encrypted data do not coincide (S3005: NO), it directly enters a standby state (S3006). After a lapse of a predetermined period of time, the application 110 detects the timeout of the data comparison mechanism 1930, and then ends this sequence (S3007).

Meanwhile, when the data comparison mechanism 1930 determines that the respectively encrypted data coincide (S3005: YES), it directly sends such data to the disk controller 160F (S3008).

When the disk controller 160F stores the respectively encrypted data sent from the coupling device 1910 in the cache (or disk), it sends a completion status to the host computer 105F (S3009).

When the host computer 105F receives the completion status, it ends this sequence (S3010).

(64) Effect of Fifth Embodiment

According to the present embodiment, by using the appliance as a device having a function of encrypting or decrypting data, since the data caused by the malfunction of the encryption processing performed by the host computer using the appliance can be detected during the writing of data, data can be reliably guaranteed in a storage system that supports the encryption function of data to be stored.

Further, since this embodiment adopts a mirror configuration, data can be reliably guaranteed by sending data in another virtual device to the host computer through a path that is different that the path for transferring data in one virtual device.

In addition, since this embodiment is equipped with a coupling device, there will be more options in selection the path upon deciding the data transfer path.

### (7) SIXTH EMBODIMENT

(7-1) System Configuration

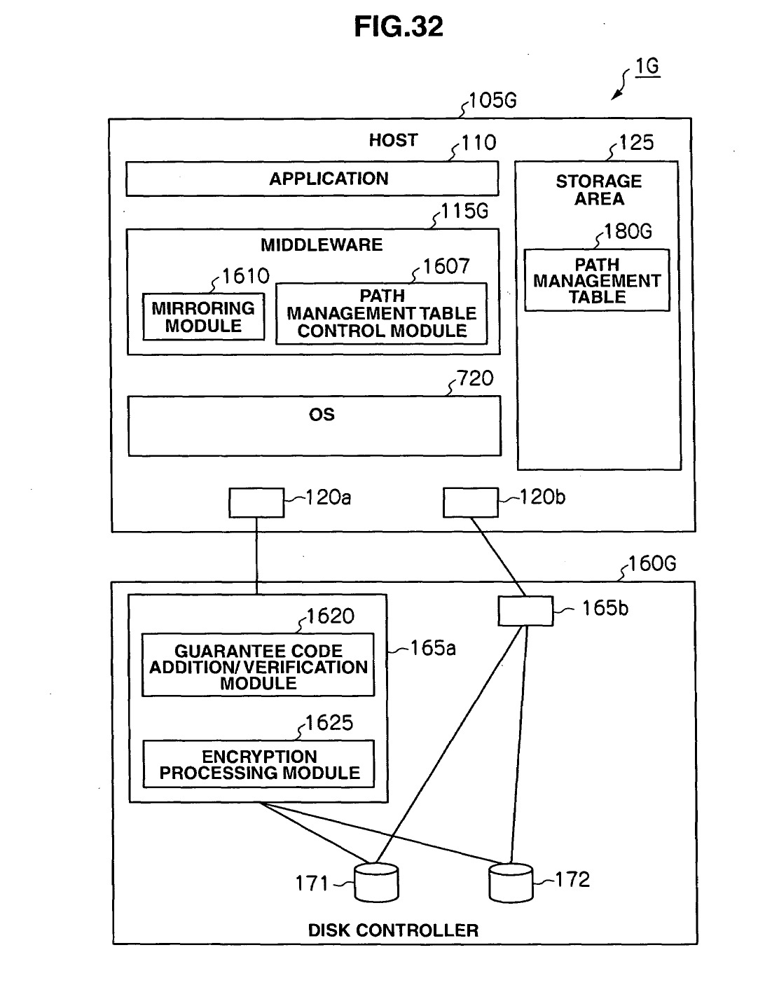

FIG. 32 is a diagram showing the configuration of the storage system according to a sixth embodiment. FIG. 32 shows the storage system 1G in this embodiment.

In this embodiment, in order to guarantee the data completeness of the storage system comprising an encryption function, the host computer 105G mirrors and stores the data in the respective logical volumes LU 171, 172. The data integrity is guaranteed by adding a error detection code and performing verification with the disk controller 160G. If the error detection codes do not coincide as a result of the comparison, it is deemed that a malfunction occurred in the encryption processing or the decryption processing.

Incidentally, the storage system 1G shown in FIG. 32 is basically the same as the storage system 1A explained in FIG. 1, and the same reference numerals are given to the same constituent elements. Only the constituent elements that are different from the storage system 1A explained in FIG. 1 are explained below.

The path management table 180G, the path management table control module 1607 and the mirroring module 1610 are the same as the path management table 180C, the path management table control module 710 and the mirroring module 725 of the second embodiment.

A error detection code addition/verification module 1620 and an encryption processing module 1625 are provided in the host adapter 165 of the disk controller 160G.

The error detection code addition/verification module 1620 adds a created error detection code to the plain text received from the host computer 105G, or verifies the plain text to which the error detection code was added.

The encryption processing module 1625 is equipped with the same function as the encryption processing mechanism 150 of the appliance 140 explained in the foregoing embodiments.

(7-2) Data Guarantee Method

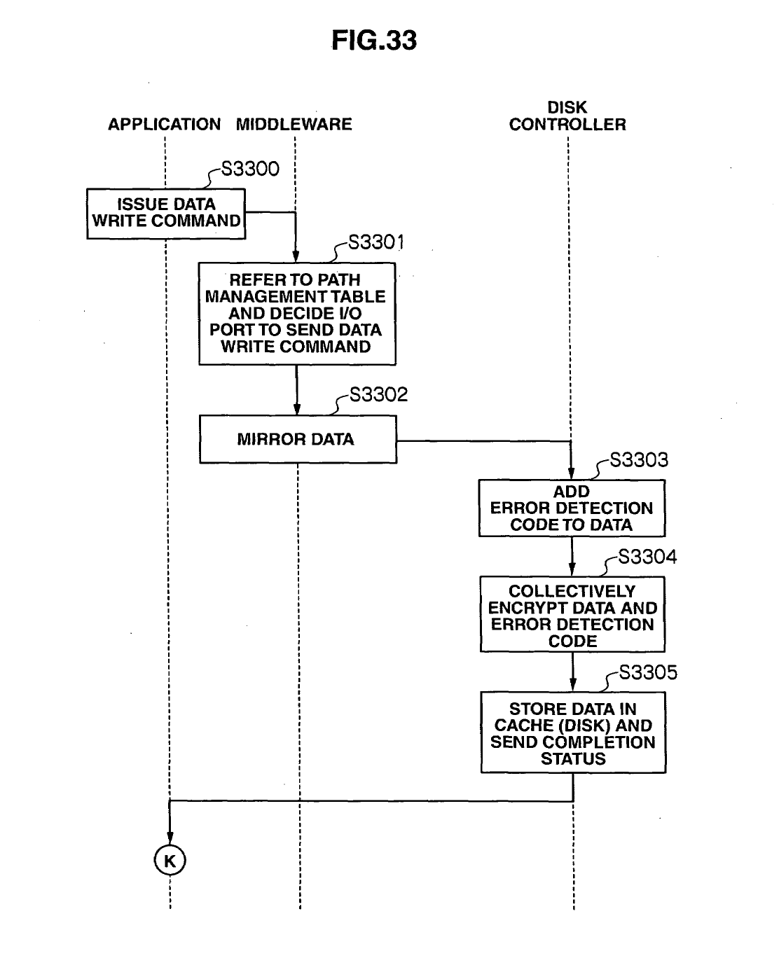

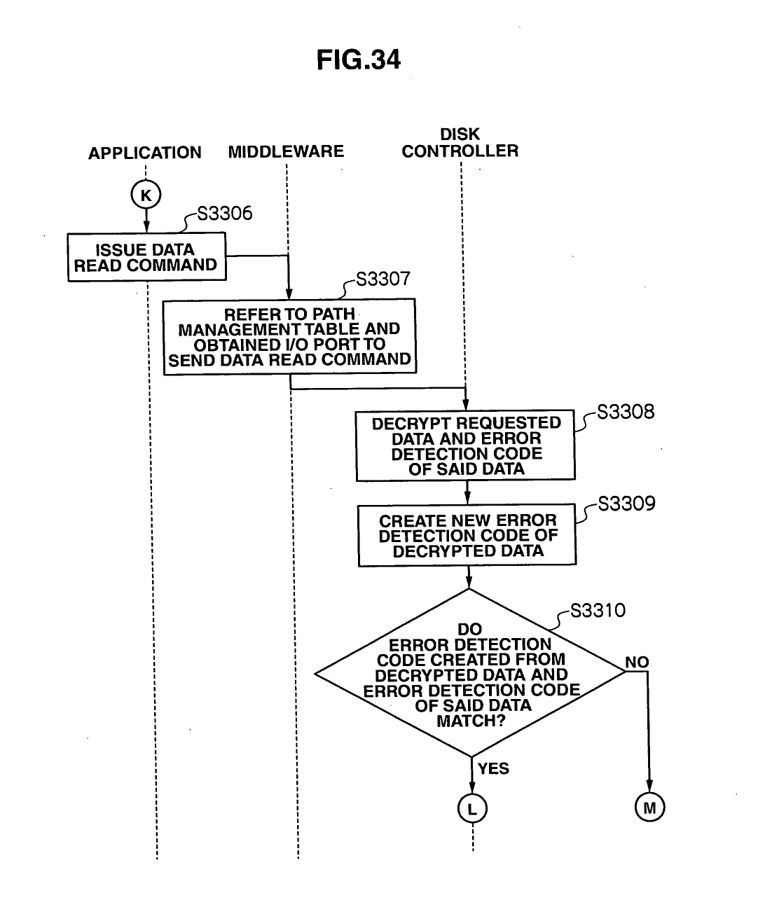

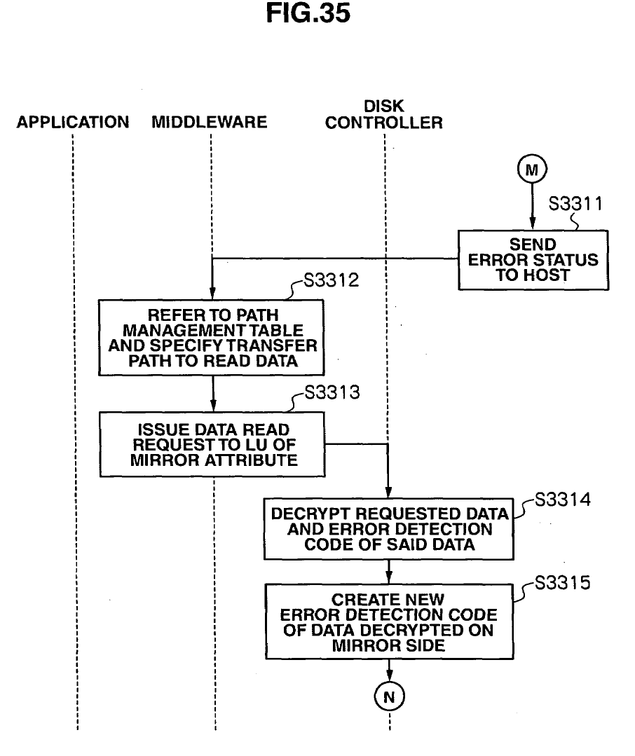

FIG. 33 to FIG. 35 are sequential diagrams of the data guarantee method in the sixth embodiment.

Specifically, when the application 110 commands the writing of data (S3300), the path management table control module 710 refers to the path management table 180G, and confirms the data transfer path to be used next (S3301). The mirroring module 1610 of the middleware 115G mirrors data so that such data is written in the respective logical volumes LU 171, 172 (S3302).

The error detection code addition/verification module 1620 of the disk controller 160G creates and adds a error detection code to the respective data received from the host computer 105G (S3303).

The encryption processing module 1625 of the disk controller 160G collectively encrypts the respective data and the error detection codes added to such data (S3304).

Subsequently, the disk controller 160G stores the respectively encrypted data and error detection codes in the cache (or logical volume LU), and sends a completion status to the host computer 105G (S3305).

When the application 110 thereafter issues a read command of the data written in the disk controller 160G (S3306), the path management table control module 1607 of the middleware 115G refers to the path management table 180G, and decides the data transfer path (S3307). The middleware 115G sends the data read command to the disk controller 160G via the decided I/O port (S3307).

The disk controller 160G reads the requested data from the cache (or disk), and decrypts the data read by the encryption processing module 1625 (S3308). Here, the encryption processing module 1625 also decrypts the error detection codes added to the data (S3308).

The error detection code addition/verification module 1620 creates a new error detection code from the decrypted data (S3309).

The error detection code addition/verification module 1620 performs a comparison to determine whether the newly created error detection code and the error detection code decrypted together with the data coincide (S3310).

When the error detection code addition/verification module 1620 determines that the newly created error detection code and the decrypted error detection code coincide (S3310: YES), the disk controller 160 sends the read data and a completion status to the host computer 105G (S3317).

When the host computer 105G receives the read data and the completion status (S3318), the middleware 115G implements the pointer movement processing (S3321), and then ends this sequence (S3322).

Meanwhile, when the error detection code addition/verification module 1620 determines that the newly created error detection code and the decrypted error detection code do not coincide (S3310: NO), it sends an error status to the host computer 105G (S3311).

When the middleware 115G receives the error status received from the disk controller 160G, the path management table control module 1607 refers to the path management table 180G, and decides the data transfer path to read the data on the mirror side (S3312).

The middleware 115G issues a data read request using the data transfer path decided at step S3312 (S3313).

The disk controller 160G reads the data and error detection code from the cache (or logical volume LU) according to the data read request, and the encryption processing module 1625 decrypts the data and the error detection code added to the data (S3314).

The error detection code addition/verification module 1620 creates a new error detection code from the data decrypted on the mirror side (S3315).

Subsequently, the error detection code addition/verification module 1620 performs a comparison to determine whether the newly created error detection code on the mirror side and the error detection code decrypted together with the mirror-side data coincide (S3316).

When the error detection code addition/verification module 1620 determines that the newly created error detection code and the decrypted error detection code coincide (S3316: YES), the disk controller 160 sends the read data and a completion status to the host computer 105G (S3317).

When the host computer 105G receives the read data and the completion status (S3318), the middleware 115G implements the pointer movement processing (S3321), and then ends this sequence (S3322).

Meanwhile, when the error detection code addition/verification module 1620 determines that the newly created error detection code and the decrypted error detection code do not coincide (S3316: NO), it sends an error status to the host computer 105G (S3319).

When the host computer 105G receives the error status (S3320), the middleware 115G implements the pointer movement processing (S3321), and then ends this sequence (S3322).

The pointer movement processing performed at step S3321, as with the pointer movement processing explained in the second embodiment, is performed by the middleware 115G according to the routine from step S2000 to step S2004.

(7-3) Effect of Sixth Embodiment

According to the present embodiment, by using the disk controller equipped with an encryption processing module as a device having a function of encrypting or decrypting data, since the data caused by the malfunction of the encryption processing performed by the host computer using the appliance can be detected during the reading of data, data can be reliably guaranteed in a storage system that supports the encryption function of data to be stored.

Further, since this embodiment adopts a mirror configuration, data can be reliably guaranteed by sending data in another virtual device to the host computer through a path that is different that the path for transferring data in one virtual device.

### (8) OTHER EMBODIMENTS

According to the first to sixth embodiments, when a malfunction occurred during the encryption processing or the decryption processing in a storage system comprising an encryption function, since it is possible to detect such malfunction at the time of receiving the write or read request from the host computer, it is possible to prevent the data from becoming garbled.

Incidentally, the “modules” explained the first to sixth embodiments are basically programs that are operated by the processor (not shown), but are not limited thereto.

In addition, with the storage system of the first to sixth embodiments, although the explanation of the network 13 and the management terminal 14 illustrated in FIG. 1 was omitted, these are provided to the storage system 1 in the first to sixth embodiments.

The storage system of the first to sixth embodiments has a host computer 105, a pair of logical volumes LU 171, 172 corresponding to the pair of virtual devices Dev to be recognized by the host computer, and a device (appliance 140 or disk controller 160) having a function of encrypting or decrypting data. And the path management unit for specifying one path for the respective logical volumes LU 171, 172 from a plurality of data transfer paths between the host computer 105 and the pair of logical volumes LU 171, 172 as provided as the path management table 180 to the host computer 105, it may also be provided to a (appliance 140 or disk controller 160) having a function of encrypting or decrypting data.

With the storage system of the first to sixth embodiments, the host computer 105 refers to the path management table upon reading data from the pair of logical volumes LU 171 or 172 corresponding to the pair of virtual device Dev to be recognized by the host computer 105 and obtains the I/O port to send the data read command. Nevertheless, if it is the same as the data transfer path to be used upon writing data, the step of referring to the path management table during the reading of data may be omitted.

Further, in the first embodiment, although the read-after-write unit, the data comparison unit and the message transmission/reception unit were provided to the middleware 115B of the host computer 105, these components may also be configured as individual hardware configurations.

In the second embodiment, although the middleware 115C of the host computer 105C included the error detection code addition unit, the mirroring unit and the error detection code verification unit, these components may also be configured as individual hardware configurations.

In the third embodiment, although the host computer 105D includes the mirroring unit and the disk controller 160D included the data comparison unit, these components may also be configured as individual hardware configurations.

In the fourth embodiment, although the host computer 105E includes the mirroring unit, the read unit and the data comparison unit, these components may also be configured as individual hardware configurations.

In the fifth embodiment, although the host computer 105F includes the mirroring unit and the coupling device 1915 includes the data comparison unit, these components may also be configured as individual hardware configurations.

In the sixth embodiment, although the host computer 105G includes the mirroring unit and the disk controller 160G includes the error detection code addition unit, these components may also be configured as individual hardware configurations.

The pointer movement processing in the second and sixth embodiments may be omitted if it is not particularly necessary to change the data transfer path.

The present invention can be broadly applied to storage systems having one or more disk controllers and storage systems of other modes.

What is claimed is:

1. A storage system, comprising:
a host computer for issuing a read command or a write command of data;
a pair of logical volumes corresponding to a pair of virtual devices to be recognized by said host computer; and
a device interposed between said host computer and said pair of logical volumes and having a function of encrypting and decrypting data;
wherein said storage system further comprises a path management unit for specifying one path to each of said logical volumes from a plurality of data transfer paths between said host computer and said pair of logical volumes for transferring encrypted data or decrypted data which was encrypted or decrypted via said device with data encryption or decryption function based on a read command or a write command of data from said host computer.

2. The storage system according to claim 1,
wherein said path management unit manages said pair of logical volumes for each of said data transfer paths,
allocates one virtual device to each data transfer path group belonging to one logical volume, and
performs virtual device allocation control by specifying one path to one virtual device from said data transfer path group, and specifying a path that is different from said specified path to another virtual device from said data transfer path group.

3. The storage system according to claim 2,
wherein said path management unit assigns an index number for each of said data transfer paths, and
controls a pointer for specifying said data path group in ascending or descending order of index numbers.

4. The storage system according to claim 1,
wherein said path management unit specifies a physical data transfer path by managing one or more host computer ports for controlling data to be input to and output from said host computer for each of said data transfer paths, and one or more volume ports for controlling data to be input to and output from said mirror logical volume.

5. The storage system according to claim 1,
wherein said host computer includes:
a read-after-write unit for storing, and thereafter reading, data stored in said logical volume as write data from said host computer;
a data comparison unit for comparing said read data, and storage data to be pre-stored in a storage area of said host computer upon being stored as said write data in said logical volume; and
a message transmission/reception unit for notifying the comparison result based on said data comparison unit; and
wherein said host computer specifies one path to each of said logical volumes.

6. The storage system according to claim 1,
wherein said host computer includes:
a error detection code addition unit for adding a error detection code to data from said host computer;
a mirroring unit for mirroring said error detection code-added data in order to write said error detection code-added data into each of said logical volumes;
a error detection code verification unit for reading said error detection code-added data from one of said logical volumes, creating a new error detection code from said read data, and verifying whether said error detection code and said new error detection code coincide; and
wherein, when said error detection code and said new error detection code do not coincide according to said error detection code verification unit, said host computer specifies one path to another logical volume from a plurality of data transfer paths between said host computer and said other logical volume.

7. The storage system according to claim 1, further comprising a controller for controlling said pair of logical volumes;
wherein said host computer includes a mirroring unit for mirroring data in order to write said data from said host computer into each of said logical volumes;
wherein said controller for controlling said pair of logical volumes includes a data comparison unit for comparing respective data mirrored based on said mirroring unit, and specifies one path to each of said logical volumes from a plurality of data transfer paths between said host computer and said pair of logical volume, and sends the mirrored data to said controller for controlling said pair of logical volumes.

8. The storage system according to claim 1,
wherein said host computer includes:
a mirroring unit for mirroring data in order to write said data from said host computer into each of said logical volumes;
a read unit for reading data from each of said logical volumes; and
a data comparison unit for comparing respective data read from said logical volume; and
wherein said host computer specifies one path to each of said logical volumes upon reading data from each of said logical volumes.

9. The storage system according to claim 1, further comprising:
a controller for controlling said pair of logical volumes; and
a coupling device for coupling a controller for controlling said pair of logical volumes and said device with data encryption or decryption function;
wherein said host computer includes a mirroring unit for mirroring data in order to write said data from said host computer into each of said logical volumes;
wherein said coupling device includes a data comparison unit for comparing said respective mirrored data, and specifies one path to each of said logical volumes upon writing mirrored data into each of said logical volumes.

10. The storage system according to claim 1,
wherein said device with data encryption or decryption function includes said pair of logical volumes;
wherein said host computer includes a mirroring unit for mirroring data in order to write said data from said host computer into each of said logical volumes; and
wherein said device with data encryption or decryption function includes:
a error detection code addition unit for adding a error detection code to mirrored data from said host computer; and
a error detection code verification unit for reading said error detection code-added data from one of said logical volumes, creating a new error detection code from said read data, and verifying whether said error detection code and said new error detection code coincide;
wherein, when said error detection code and said new error detection code do not coincide according to said error detection code verification unit, said host computer specifies one path to another logical volume from a plurality of data transfer paths between said host computer and said other logical volume.

11. A data guarantee method of a storage system comprising a host computer for issuing a read command or a write command of data, a pair of logical volumes corresponding to a pair of virtual devices to be recognized by said host computer, and a device interposed between said host computer and said pair of logical volumes and having a function of encrypting and decrypting data,
said data guarantee method comprising a path management step of specifying one path to each of said logical volumes from a plurality of data transfer paths between said host computer and said pair of logical volumes for transferring encrypted data or decrypted data which was encrypted or decrypted via said device with data encryption or decryption function based on a read command or a write command of data from said host computer.

12. The data guarantee method according to claim 11,
wherein, at said path management step, said pair of logical volumes is managed for each of said data transfer paths,
one virtual device is allocated to each data transfer path group belonging to one logical volume, and
virtual device allocation control is performed by specifying one path to one virtual device from said data transfer path group, and specifying a path that is different from said specified path to another virtual device from said data transfer path group.

13. The data guarantee method according to claim 12,
wherein, at said path management step, an index number is assigned for each of said data transfer paths, and
a pointer is controlled for specifying said data path group in ascending or descending order of index numbers.

14. The data guarantee method according to claim 11,
wherein, at said path management step, a physical data transfer path is specified by managing one or more host computer ports for controlling data to be input to and output from said host computer for each of said data transfer paths, and one or more volume ports for controlling data to be input to and output from said mirror logical volume.

15. The data guarantee method according to claim 11,
wherein said host computer includes:
a read-after-write step of storing, and thereafter reading, data stored in said logical volume as write data from said host computer;
a data comparison step of comparing said read data, and storage data to be pre-stored in a storage area of said host computer upon being stored as said write data in said logical volume; and
a message transmission/reception step of notifying the comparison result based on said data comparison unit; and
wherein, at said path management step, one path is specified for each of said logical volumes.

16. The data guarantee method according to claim 11,
wherein said host computer includes:
a error detection code addition step of adding a error detection code to data from said host computer;
a mirroring step of mirroring said error detection code-added data in order to write said error detection code-added data into each of said logical volumes;
a error detection code verification step of reading said error detection code-added data from one of said logical volumes, creating a new error detection code from said read data, and verifying whether said error detection code and said new error detection code coincide; and
wherein, at said path management step, when said error detection code and said new error detection code do not coincide according to said error detection code verification unit, one path is specified for another logical volume from a plurality of data transfer paths between said host computer and said other logical volume.

17. The data guarantee method according to claim 11,
wherein said storage system further comprises a controller for controlling said pair of logical volumes;
wherein said host computer includes a mirroring step of mirroring data in order to write said data from said host computer into each of said logical volumes;
wherein said controller for controlling said pair of logical volumes includes a data comparison step of comparing respective data mirrored based on said mirroring unit; and
wherein, at said path management step, one path is specified for each of said logical volumes from a plurality of data transfer paths between said host computer and said pair of logical volume, and sends the mirrored data to said controller for controlling said pair of logical volumes.

18. The data guarantee method according to claim 11,
wherein said host computer includes:
a mirroring step of mirroring data in order to write said data from said host computer into each of said logical volumes;
a read step of reading data from each of said logical volumes; and
a data comparison step of comparing respective data read from said logical volume; and
wherein, at said path management step, one path is specified for each of said logical volumes upon reading data from each of said logical volumes.

19. The data guarantee method according to claim 11,
wherein said storage system further comprises a controller for controlling said pair of logical volumes; and
a coupling device for coupling a controller for controlling said pair of logical volumes and said device with data encryption or decryption function;
wherein said host computer includes a mirroring step of mirroring data in order to write said data from said host computer into each of said logical volumes;
wherein said coupling device includes a data comparison step of comparing said respective mirrored data; and
wherein, at path management step, one path is specified for each of said logical volumes upon writing mirrored data into each of said logical volumes.

20. The data guarantee method according to claim 11,
wherein said device with data encryption or decryption function includes said pair of logical volumes;
wherein said host computer includes a mirroring step of mirroring data in order to write said data from said host computer into each of said logical volumes; and
wherein said device with data encryption or decryption function includes:
a error detection code addition step of adding a error detection code to mirrored data from said host computer; and
a error detection code verification step of reading said error detection code-added data from one of said logical volumes, creating a new error detection code from said read data, and verifying whether said error detection code and said new error detection code coincide;
wherein, when said error detection code and said new error detection code do not coincide according to said error detection code verification step, at said path management step, one path is specified for another logical volume from a plurality of data transfer paths between said host computer and said other logical volume.
